(19) United States
(12) Patent Application Publication
(10) Pub. No.: US 2025/0299466 A1
(43) Pub. Date: Sep. 25, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KAZUFUMI KONDO, Kanagawa (JP); TAKASHI NAKAMURA, Kanagawa (JP); YOSHINORI MIZOGUCHI, Tokyo (JP); TAKAYUKI YAMADA, Kanagawa (JP); AKITOSHI YAMADA, Kanagawa (JP); HISASHI ISHIKAWA, Chiba (JP)

(21) Appl. No.: 19/081,718

(22) Filed: Mar. 17, 2025

(30) Foreign Application Priority Data
Mar. 19, 2024 (JP) 2024-043653

(51) Int. Cl. G06V 10/44; G06T 1/60; G06T 7/11; G06V 10/764

(52) U.S. Cl. CPC G06V 10/454; G06T 1/60; G06T 7/11; G06V 10/764

(57) ABSTRACT

An information processing apparatus has at least one memory storing a plurality of convolution layers, and a processor. The processor propagates output data based on a feature quantity vector extracted from input data from a preceding stage to a subsequent stage; concatenates a forward propagation path in which the output data is propagated sequentially through each of the plurality of convolution layers with a bypass path in which the output data is propagated while bypassing part of the forward propagation path; and performs convolution processing of extracting the feature quantity vector from the input data at each convolution layer. In the extraction processing in the bypass path, processor performs partial extraction processing to extract part of attribute information on the feature quantity vector. If the bypass path is used, the processor concatenates an output result from the forward propagation path with a result of the partial extraction processing.

### BACKGROUND

### Field of the Disclosure

The present disclosure relates to an information processing apparatus, an information processing method, and a storage medium.

### Description of the Related Art

Conventionally, skip connections are used in neural network learning. A skip connection is a configuration in deep neural networks which uses a bypass path connecting a certain layer to a deeper layer while skipping a plurality of layers in between to enable forward propagation or backward propagation between layers distant from each other. While skip connections improve the vanishing gradient problem, they degrade the neural network's generalization performance. In view of these aspects of skip connections, International Publication No. WO2019/167665 (hereinafter referred to as Literature 1) discloses a technique which selects a skip connection to be disabled and blocks error propagation only at the selected skip connection. The technique disclosed in Literature 1 performs processing for selecting a skip connection to be disabled in every learning of a neural network. This enables learning to be repeatedly performed using neural nets in which layers are connected differently. Thus, the technique disclosed in Literature 1 can achieve ensemble learning and therefore improves the generalization performance of the neural network as a whole.

There is another aspect to skip connections: it is necessary to keep holding processing results obtained previously. In general, as more processing results are held, the circuit area used for memory space increases. Thus, while the technique disclosed in Literature 1 improves the generalization performance of a neural network as a whole, it increases costs due to an increase in the circuit area used as memory space. For example, cache memory used to hold processing results is often formed of static random access memory (SRAM), which is expensive memory. Thus, it is desirable not to increase the area of a circuit used as SRAM memory space. However, not increasing the area of a circuit used as SRAM memory space results in shortage of memory space used to keep holding processing results, which may hinder implementation of the above-described skip connections.

### SUMMARY

An information processing apparatus according to an aspect of the present disclosure is an information processing apparatus having: at least one memory storing a plurality of convolution layers; and a processor connected to the at least one memory. The processor causes each of the plurality of convolution layers to propagate output data to a subsequent stage side, the output data being based on a feature quantity vector extracted from input data from a preceding stage side at each of the plurality of convolution layers. The processor concatenates a forward propagation path in which the output data is propagated sequentially through each of the plurality of convolution layers with a bypass path in which the output data is propagated while bypassing part of the forward propagation path. The processor performs convolution processing of extracting the feature quantity vector from the input data at each of the plurality of convolution layers. In the processing for extracting the feature quantity vector, as processing of extracting the feature vector in the bypass path, the processor performs partial extraction processing to extract part of attribute information on the feature quantity vector, and in the concatenating of the forward propagation path with the bypass path, in a case where the bypass path is used, the processor concatenates an output result from the forward propagation path and a result of the partial extraction processing.

Further features of various embodiments will become apparent from the following description of exemplary embodiments with reference to the attached drawings.

### BRIEF DESCRIPTION OF THE DRAWINGS

FIG. 1 is a block diagram showing the configuration of an inferencing execution apparatus.

FIG. 2 is a conceptual diagram showing an example configuration of an inference unit.

FIG. 3 is a schematic diagram showing the configuration of a skip connection.

FIG. 4 is a conceptual circuit diagram of a filter constituting the inference unit.

FIG. 5 is a schematic diagram showing the vicinity of an input part of a CNN.

FIG. 6 is a flowchart illustrating an overview of processing executed by a convolution layer.

FIG. 7 is a schematic diagram showing details of a neuron constituting a CNN.

FIG. 8 is a flowchart illustrating convolution processing.

FIG. 9 is a schematic diagram showing the vicinity of an output part of a CNN.

FIG. 10 is a conceptual circuit diagram of a filter constituting the inference unit.

FIG. 11 is a conceptual diagram showing an image used for learning.

FIG. 12 is a conceptual diagram of a filter constituting the inference unit.

FIG. 13 is a flowchart illustrating learning.

FIG. 14 is a flowchart showing a re-extraction operation.

FIG. 15 is a diagram showing an example where a feature vector of the fifth layer is skip-connected.

FIG. 16 is a conceptual circuit diagram of a filter constituting the inference unit.

FIG. 17 is a schematic diagram of CNN processing.

FIG. 18 is a conceptual circuit diagram of a filter constituting the inference unit.

FIG. 19 is a schematic diagram illustrating a skip connection using dimension-compressed feature vectors.

FIG. 20 is a schematic diagram of a model that performs skip connections.

FIG. 21 is a schematic diagram illustrating details of a skip connection.

FIG. 22 is a diagram showing a settings screen for leaning of a CNN model.

FIG. 23 is a diagram showing an example of an advanced settings screen for learning of a CNN model.

FIG. 24 is a diagram showing another example of an advanced settings screen for learning of a CNN model.

FIG. 25 is a flowchart showing automatic CNN model designing.

### DESCRIPTION OF THE EMBODIMENTS

Example embodiments of the present disclosure are described in detail below with reference to the drawings attached hereto. Note that the embodiments below do not limit the matters of the present disclosure, and the combinations of features described in the embodiments below are not necessarily essential as solutions provided by the present disclosure. Note that the same constituents are denoted by the same reference numerals.

### First Embodiment

### Overview

With repeated learning of a neural network, the gradient found by error backpropagation becomes smaller and smaller and eventually vanishes. This is generally known as the vanishing gradient problem. To solve the vanishing gradient problem, a skip connection is employed. A skip connection is a configuration in deep neural networks which uses a bypass path connecting a certain layer to a deeper layer while skipping a plurality of layers in between to enable forward propagation or backward propagation between layers distant from each other. In a skip connection, a bypass path skipping some of a plurality of layers constituting the neural network is provided, so that the bypass path and a forward propagation path are provided in parallel. Such a path configuration makes it possible to propagate features to a distant layer via a different path, skipping some of the plurality of layers. Thus, features that will be lost more and more by, e.g., convolution processing performed at preceding ones of the plurality of layers, can be propagated to a subsequent one of the plurality of layers. However, to implement a skip connection, it is necessary to keep holding feature vectors extracted from the layers. Thus, more memory space is needed in a case where a skip connection is employed than in a case where a skip connection is not employed. Also, in holding the feature vectors of the layers and using them as needed for a skip connection, efficient processing is achieved by having the feature vectors held not in main memory, but rather in cache memory. This means a need for larger cache memory. Typically, SRAM is used as cache memory, but SRAM is expensive. Thus, in order to implement skip connections at lower costs, the present embodiment performs the following operation instead of keeping holding feature vectors extracted by the layers. Specifically, as processing for extracting feature vectors in a bypass path, partial extraction processing is performed to extract part of attribute information on the feature vectors. Further, in a case where a bypass path is used, a result outputted from a forward propagation path and a result of the partial extraction processing are concatenated. Such an operation makes it possible to implement a skip connection without increasing the area of a circuit used as expensive SRAM memory space. Note that the model configuration of a neural network is not limited to a particular one. For example, it may be a convolution neural network forming an encoder-decoder model or Inverted Residual in a model typified by a ResNet. Main terms used herein are defined as follows.

### Term Definitions

### Artificial Neuron

An artificial neuron is a unit of processing formed by a filter and an activation function unit. Convolution coefficients of the filter are also referred to as “weights”. Convolution coefficients of a filter are also referred to as “weights of an artificial neuron” where appropriate. An artificial neuron receives input data for the filter. In a case of a 3×3 filter, for example, an artificial neuron receives 5×5 input data, transfers a convolved value to the activation function unit, and outputs a feature value calculated by the activation function unit.

### Activation Function Unit

An activation function unit is a function with non-linear response characteristics. Although the softmax function is used here, it may be the rectified linear unit (ReLU) function. Using a function with non-linear response characteristics causes the input-output relation to have non-linear response characteristics, but the present disclosure is not limited to this. For example, the activation function unit may be a function with linear response characteristics, or the activation function unit may be the identity function. For example, in a case of sending a feature vector to a distant layer using a skip connection, the activation function unit may be implemented by the identity function.

### Layer

A layer is a unit of processing formed by a plurality of artificial neurons. In principle, common data is inputted to each artificial neuron. However, different convolution coefficients (weights) may be set for the artificial neurons according to the features to be obtained. The reason why a layer is formed by a plurality of artificial neurons is to analyze various aspects of input data.

### Feature Value

An output from a single artificial neuron is called a feature value. Different artificial neurons output different feature values. Note that a feature value may be outputted from an artificial neuron as a certain index such as strength.

### Feature Vector

A feature vector is a vector formed by a plurality of feature values outputted from a single layer. The dimension of this vector is hereinafter referred to as a “channel.”

### Underlying Technologies

Example embodiments of the disclosure are described below with reference to the drawings. The embodiments assume and describe a case where learning results necessary for an edge AI terminal to perform inferencing have already been learned externally. An edge AI terminal is a product where the product itself can benefit from an outcome from the artificial intelligence. An edge AI terminal does not have to equipped with both “learning” and “inferencing” needed in a convolution neural network (CNN). A product can implement “inferencing” by holding parameters obtained as a result of learning and prepared in advance. A CNN is one of pattern recognition technologies using machine learning. Also, a CNN is one of processing methods used by a manufacturer to enhance the functionality of the product to differentiate the product from other products. An overview of an operation performed by a CNN for pattern recognition is described below.

### Overview of the Operation of a CNN

First, features of input data is extracted using a feature value extraction method prepared in advance. A description is now given of the feature value extraction method. Feature values can be extracted by an enormous amount of convolution processing using multi-stage filters. The multi-stage filters are formed by a plurality of filters and a plurality of activation function units. Each of the plurality of activation function units is disposed at a stage subsequent to its corresponding one of the plurality of filters. A pair of a single filter and a single activation function unit corresponds to the “artificial neuron” defined above. The activation function unit is, for example, a function whose response to an input is non-linear. Each filter has convolution coefficients. A description is now given of how the convolution coefficients are determined. The convolution coefficients can be determined in advance using an enormous amount of data with an aim to define a pattern type. Specifically, convolution coefficients can be determined by optimization of the convolution coefficients using an enormous amount of prepared correct-answer data until unknown data gets the correct answer at a high rate. Such a determination method is hereinafter referred to as “learning”. Feature values of input data are extracted by convolution processing performed an enormous number of times using convolution coefficients obtained as a result of learning. Because a feature value of input data thus obtained is obtained by each artificial neuron, there is not necessarily one type of feature value. At least some of the plurality of feature values of input data correspond to the “feature vector” defined above. A CNN thus extracts a feature vector from input data.

Next, using an output from the final layer of the CNN, the CNN identifies which of the predetermined types the feature vector matches. In this way, input data is classified into a known pattern. Pattern recognition is thus implemented. Such pattern recognition corresponds to the “inferencing” described earlier.

Note that a CNN may be implemented by an encoder-decoder model formed by encode layers and decode layers. The attributes of pixels may be determined on a pixel-by-pixel basis by the encoder-decoder model. The encoder-decoder model determines the attributes of all the pixels of an image. In other words, the encoder-decoder model can also determine attributes on a pixel-by-pixel basis. Such processing is hereinafter referred to as “regional segmentation” or simply as “segmentation”. Note that “segmentation” here corresponds to what is called semantic segmentation. By collecting determination results on the pixel attributes of the respective pixels, it is possible to identify whether successive pixels are the same target. Specifically, the encode layers perform downsampling from input data and thereby extracts feature values in a wide area. Meanwhile, the decode layers derive a final determination result by upsampling the extracted feature values at the same resolution as the input data. A CNN configured as an encoder-decoder model has, for example, the following characteristics. One of them is that input data reaches the final determination result after a very large number of layers. This consequently leads to another characteristic where the resolution changes in the middle layers of the processing.

There is also another characteristic where an artificial neuron used in a CNN includes the above-described filter. The filter performs convolution processing on input data. As described above, the filter has convolution coefficients. The convolution coefficients are in other words “weights”. A CNN compares a feature value obtained through a model with a true value. Specifically, a CNN finds the difference between a calculated feature value and a true value. This difference is referred to as an “error”. Finding a “weight” to decrease this error is a method called an error backpropagation method. Also, optimizing the convolution coefficients by using the error backpropagation method repeatedly is a specific example of the “learning” described above. Determining convolution coefficients through learning is also another characteristic of a CNN.

### Skip Connection

The above characteristics may cause a phenomenon where, for example, error backpropagation does not progress correctly in learning. The reason for this is because in deeper layers, processing results by the error backpropagation method become smaller, hindering the progress of learning. Such a phenomenon is hereinafter referred to as “gradient vanishing”. Also, another phenomenon may be caused where information indicating a local feature of the input data which was held at the time of encoding is lost because the resolution changes at every pass through a layer. These phenomena may degrade the accuracy of learning. As a countermeasure against such degradation of learning accuracy, a “skip connection” has conventionally been used. In a case of an encode-decode model, a skip connection may be implemented by reusing data in the encode layers for the convolution processing in the decode layers. Such an operation improves the quality of information in decoding by using information lost in encoding. At the same time, in learning, such an operation achieves favorable error backpropagation including a feedback component produced by a skip connection as well. Thus, the above operation enables learning where a local edge lost in encoding is recovered. Also, a region's border portion in an image can be accurately determined. However, in a case where a skip connection is employed, for example, it is necessary to pass a processing result in the encoder layers over to the decode layers. Thus, as the layer used in encoding becomes deeper and deeper, more and more processing results from the artificial neurons are held in the SRAM. The reason for this is because in order to use results of encoding for decoding, all the processing results need to be held in the SRAM.

Also, a CNN can be used for image recognition. In order to use a CNN for image recognition, convolution processing is performed on the entire image. A description is now given of a more specific example of a filter used in convolution processing. As an example, a case is considered where a single 3×3 filter is applied to an image. Convolution processing is processing where the sum of the products of convolution coefficients and pixels included in an image is used as the value of the center pixel. Thus, in a case where a 3×3 filter is applied to a 3×3 image, the value of only the single center pixel is found. In order to apply a 3×3 filter also to neighboring pixels surrounding the 3×3 image, a 5×5 image is needed. Those surrounding pixels needed in the convolution processing depending on a necessary image region are hereinafter referred to as “glue margin”. As each filter increases in size and as the number of filters stacked increases two-dimensionally in the CNN as a whole, even larger glue margins are needed. Thus, the amount of necessary glue margin increases three-dimensionally. The increase in the glue margin means that usage of memory space needs to increase accordingly. For example, in the convolution processing, data obtained from main memory is loaded into cache memory. SRAM is typically used as the cache memory. Thus, in a situation where the glue margin increases, SRAM memory space usage increases. Especially in a case where not a single or two filters, but an enormous number of filters are stacked, SRAM memory space usage increases three-dimensionally.

Hence, in a case where convolution processing using filters is performed on many layers, a vast amount of memory space is needed in the SRAM. Further, employing skip connections also requires a vast amount of memory space in the SRAM. For example, with an encoder-decoder model, using a skip connection improves the reliability of data in decoding; however, necessary SRAM memory space increases exponentially. Because SRAM is expensive, increasing the SRAM memory space to a great extent increases costs. Meanwhile, not increasing the SRAM memory space results in shortage of cache memory needed for skip connections. Although a skip connection in an encoder-decoder model is described as an example above, it is to be noted that for any other model, large cache memory is usually needed for skip connections, which hinders skip connections to be enabled at low cost. In view of such a situation, in the present embodiment, configurations and operations for enabling a skip connection at low costs are described below sequentially.

### Overall Configuration of the Inferencing Execution Apparatus

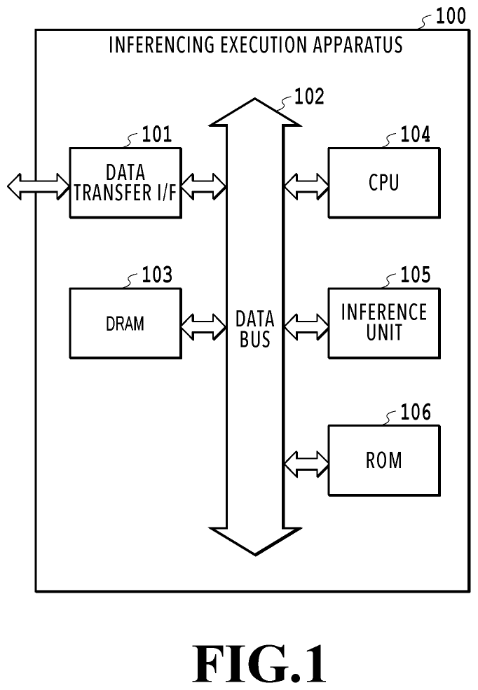

FIG. 1 is a block diagram showing the configuration of an inferencing execution apparatus. An inferencing execution apparatus 100 is an information processing apparatus mounted in a product. The present embodiment assumes that the product is a printer. However, the product in which the inferencing execution apparatus is mounted is not limited to a printer, and the configuration of the present embodiment can be applied to products such as a personal computer or a smartphone which incorporate a CPU or a processing circuit similar to a CPU, such as or an ASIC or an FPGA. The inferencing execution apparatus 100 has a data transfer I/F 101, a data bus 102, and a dynamic random access memory (DRAM) 103. The inferencing execution apparatus 100 also has a central processing unit (CPU) 104, an inference unit 105, and a read-only memory (ROM) 106. The data transfer I/F 101 is an interface for input and output of data from and to a device external to the product (not shown). Examples of the external device include devices such as a personal computer and a mobile phone which are capable of generating or holding input data and transferring the input data to the product. The data bus 102 is a data bus for transferring various kinds of data received from the data transfer I/F 101 to functional blocks to be described later. The DRAM 103 is a region where various kinds of data received from the data transfer I/F 101 are temporarily stored. The CPU 104 delivers input data stored in the DRAM 103 through the data bus 102 to perform necessary processing thereon. The inference unit 105 is a functional block that receives data divided into image blocks and performs inferencing thereinside. The inference unit 105 has SRAM. The ROM 106 is a region for holding various kinds of data for the inference unit 105. For example, the ROM 106 can store convolution coefficients determined previously as a result of learning. Also, as will be described later, the ROM 106 also stores the size of the image blocks which are passed from the DRAM 103 to the inference unit 105. These configurations are exemplary, and for example, any other storage medium may be used in place of the ROM 106. Any other storage medium may be, for example, an HDD or external memory using a USB interface. Also, in the present embodiment, inferencing is performed in the inference unit 105. Alternatively, firmware for implementing equivalent mechanisms may be stored in a storage medium and have the CPU 104 perform the processing. Also, as functionality expansion, the size of image blocks passed from the DRAM 103 to the inference unit 105 may be delivered as a parameter via the data transfer I/F 101.

### Inference Unit

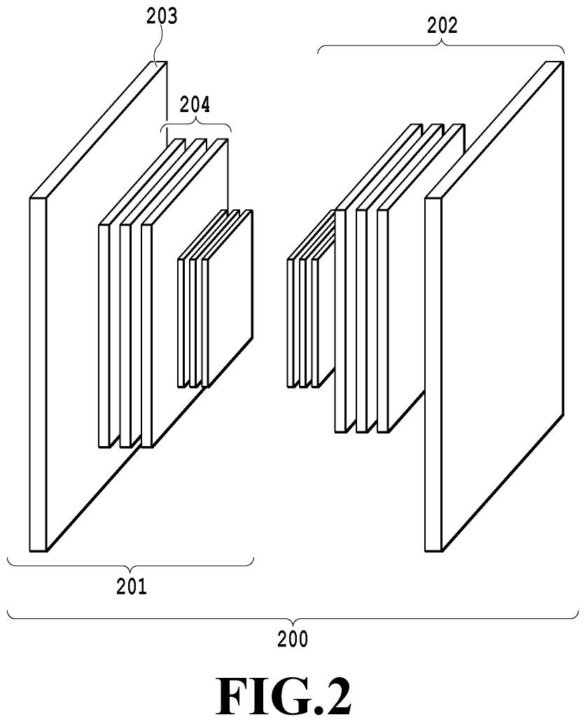

FIG. 2 is a conceptual diagram showing an example configuration of the inference unit 105. It is assumed that the inference unit 105 in FIG. 2 operates in accordance with an encoder-decoder model. Examples of the encoder-decoder model include SegNet and U-Net. The CPU 104 executes various programs so that the inference unit 105 may implements various functional configurations as an inferencing unit 200. The inferencing unit 200 includes encode layers 201 and decode layers 202. The encode layers 201 include an input layer 203 and processing layers 204. The encode layers 201 encode features in input data. The decode layers 202 decode processing results obtained by the encode layers 201 and extract a feature vector. Input data is inputted to the input layer 203. A layer is a single action body that implements some type of processing using a large number of filters successively in a CNN model. It does not necessarily mean that a plurality of filters are needed as physical configurations. Updating convolution coefficients step by step and using a processing result for processing at the next filter mean that processing is performed through two consecutive filters. The input layer 203 is depicted here as an example of such a layer. The processing layers 204 are layers for receiving input data supplied from the input layer 203 and performing subsequent processing. Through such processing, encoding is performed in the first half part. The layers subsequent to these layers are configured using a plurality of filters, as the input layer is. The decode side, like the encode side, has a configuration having processing layers using a plurality of filters. In the example in FIG. 2, each layer is depicted as a cube with rectangular faces, and the size of the layer indicates resolution. Specifically, at the encode side, resolution decreases as processing proceeds through the layers, and at the decode side, resolution increases as processing proceeds through the layers. The following describes using a large number of filters consecutively. Also, the final output from the decode side is uniquely determined by the processing performed by an activation function unit in the final layer. The probability of the attribute of a pixel is determined by a result of processing by the activation function unit. Note that because the example in FIG. 2 assumes an encoder-decoder model, descriptions about the decode layers in a CNN are omitted. In the example CNN in FIG. 2, several layers are formed by combining a plurality of two-dimensional filters. The layers thus configured are combined to perform encoding and decoding. A feature vector is obtained through these processes. Although an encoder-decoder model is assumed for the inference unit 105 in FIG. 2, the model is not particularly limited to this model. For example, the ResNet model may be assumed. In a configuration with the ResNet model, a plurality of stages of convolution layers and pooling layers are provided after the input layer, and then after that, a fully-connected layer and an output layer are provided.

### Overview of a Skip Connection

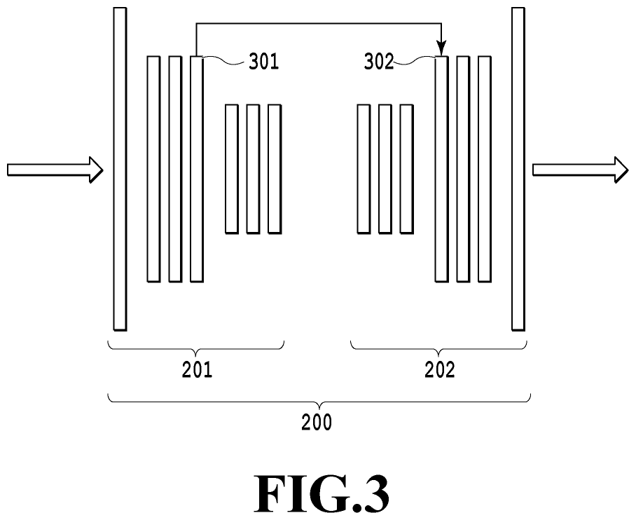

Next, a skip connection is described. FIG. 3 is a schematic diagram showing the configuration of a skip connection. In the present embodiment, the encode layers 201 are depicted as seven rectangles in the drawings. Each of the seven rectangles indicates a layer. Each layer has a plurality of artificial neurons. The length of each rectangle indicates the resolution of input data. Thus, the shorter the length of a rectangle, the lower the resolution of input data, and the longer the length of a rectangle, the higher the resolution of input data. Thus, FIG. 3 shows an example case where the encode layers 201 are formed by seven layers. Note that the layer configuration is not limited to this as long as each layer is configured combining artificial neurons so that desired feature values can be extracted. Each convolution layer performs convolution processing using a sum-of-product operation, and the pooling layer consolidates results of the convolution processing to a representative value. As a result, a feature value in input data is extracted, and at the same time, culling is performed on the input data. Consequently, the input data is subjected to compression processing (hereinafter also referred to as downsampling). Specifically, downsampling is pooling where a plurality of values obtained by convolution processing are consolidated into a representative value using a particular algorithm. An example of the particular algorithm used for the pooling is processing for finding the average value of the plurality of values obtained by the convolution processing. The plurality of values obtained by the convolution processing are thus consolidated into a single representative value. Another example of the particular algorithm used for the pooling is processing for fining the largest value among the plurality of values obtained by the convolution processing. The plurality of values obtained by the convolution operations are thus consolidated into a single representative value. Thus, performing pooling enables mitigation of degradation of performance caused by a change in the position of coordinates in an image. Note that downsampling may be performed without pooling layers as follows: the scan width for the filter (a stride) at the time of convolution is increased, and as a result, a feature value is obtained from a scaled-down image. With any method, a feature vector as an output value can be obtained from any layer in the encoding. The same applies to the processing layers on the decode side. However, on the decode side, upsampling layers are used to perform processing for increasing the resolution of feature values. In regular processing, data is inputted to the input layer 203, and processing proceeds toward the subsequent-stage side of the input layer. This processing direction is the forward propagation direction. An output layer 301 is a layer that outputs a feature vector as found at the point of this layer. A dimension addition layer 302 is a layer where a dimension is added using the feature vector outputted from the output layer 301. A description is now given of adding a dimension. In general, the dimension of the sum of an n-dimensional vector and an n-dimensional vector is an n-dimension. No mathematical addition is defined for an n-dimensional vector and an m-dimensional vector. Adding dimensions does not mean vector addition, but means generating an (n+m)-dimensional vector by simply arranging vectors of different dimensions. Such processing is hereinafter referred to as “dimension concatenation”. Such a processing method where at the time of inputting an output from a given layer on the encode side to a given layer on the decode side, the output is arranged in such a manner as to add dimensions is called a skip connection. In other words, a skip connection is an operation of increasing vector elements. Note that the upsampling layer may perform processing for decompressing data by interpolation or by transposed convolution processing or up-convolution processing.

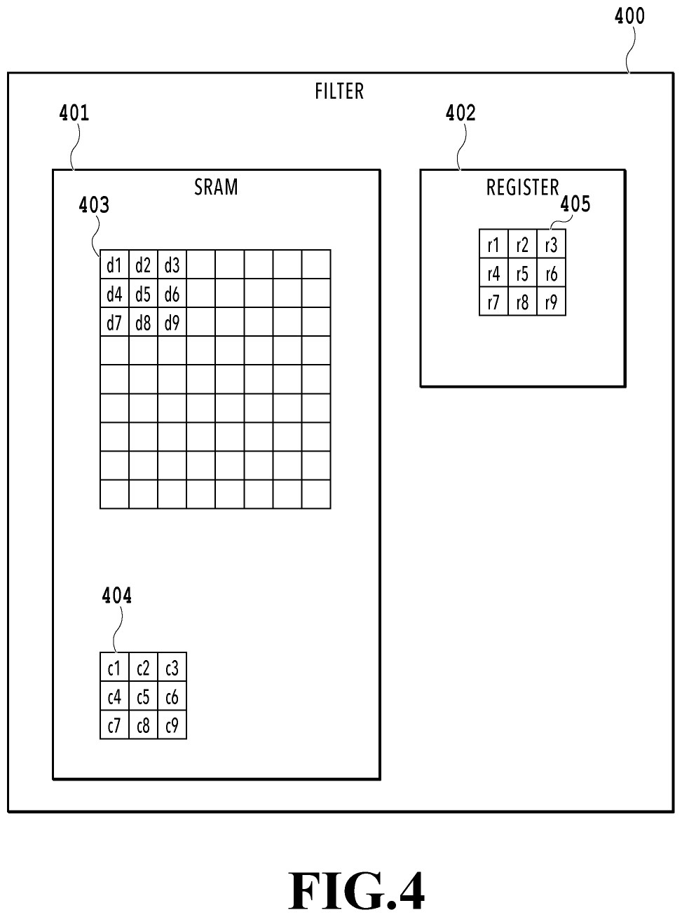

Based on the above, the information processing apparatus according to the present embodiment has the following configuration irrespective of the model. Specifically, the information processing apparatus has a convolution layer set, a concatenating unit, and a processing unit. The convolution layer set has a plurality of convolution layers. Each of the plurality of convolution layers of the convolution layer set propagates output data to a subsequent stage, the output data being based on a feature vector extracted from input data inputted from a preceding stage. Here, a preceding stage of each convolution layer means a stage immediately before the convolution layer, and a subsequent stage of each convolution layer means a stage immediately after the convolution layer. The concatenating unit is implemented by the CPU 104 in FIG. 1. The coupling unit concatenates a forward propagation path and a bypass path. In a forward propagation path, output data is propagated from one of a plurality of convolution layers to another, sequentially passing through the convolution layers present in between. In a bypass path, output data is propagated from one of the convolution layers to another, bypassing part of the forward propagation path. The processing unit is implemented by the CPU 104 in FIG. 1. The CPU 104 in FIG. 1 extracts a feature vector from input data at each of the plurality of convolution layers. The CPU 104 in FIG. 1 performs, as re-extraction processing, processing of re-extracting feature vectors included in ones of the plurality of convolution layers up to the one where bypassing using a bypass path starts. In a case where re-extraction processing is performed by the processing unit, the conatenating unit concatenates an output result from the forward propagation path to a result of the re-extraction processing performed by the processing unit. This configuration enables a skip connection to be established without holding, in the cache memory, the feature vectors of the respective layers in the forward propagation path because the feature vectors of the respective layers are re-extracted. This makes a skip connection possible at low costs. Note that input data is formed by a plurality of elements. The plurality of elements are, for example, a plurality of pixels. Thus, input data is formed by, for example, a plurality of pixels. Also, each of the plurality of convolution layers has a filter where a plurality of convolution coefficients are specified. A description of this filter will be given later using FIGS. 4, 10, 12, 16, and 18. In each of the plurality of convolution layers, the CPU 104 in FIG. 1 extracts a feature vector by performing convolution processing based on a plurality of pixels and a plurality of convolution coefficients. Such an operation enables extraction of a feature vector using a filter. Specifically, the CPU 104 in FIG. 1 performs a sum-of-product operation on input data while shifting the filter at a certain stride and thereby finds a feature value at every shift of the filter, the feature value representing a local feature in the input data. The CPU 104 then extracts a collection of the feature values thus found, as a feature vector. Such an operation makes it possible to extract a feature vector from input data using a filter. Note that shifting a filter herein means that among the pixels of input data loaded into the memory space, a region of pixels to be processed by the convolution coefficients of the filter is shifted as a certain stride. Thus, it does not mean physically moving the filter.

### Circuit Configuration of the Filter

FIG. 4 is a conceptual circuit diagram of a filter 400 constituting the inference unit 105. The filter 400 has SRAM 401 and a register 402. In the example in FIG. 4, data 403 and a convolution coefficient dataset 404 are loaded into memory space in the SRAM 401. The data 403 is obtained from the DRAM 103 functioning as main memory and is loaded into a predetermined area of the memory space on the SRAM 401. The data 403 is formed by pixels d1 to d9. The convolution coefficient dataset 404 is formed by c1 to c9 arranged in 3×3. Disposed in the register 402 is a dataset 405 of r1 to r9 arranged in 3×3 like the convolution coefficient dataset 404. In the convolution processing, the dataset 405 of r1 to r9 is used to maintain the 3×3 positional relation (coordinates).

### Method for Generating the Convolution Coefficients

Next, a method for generating convolution coefficients is described.

### Generation Environment

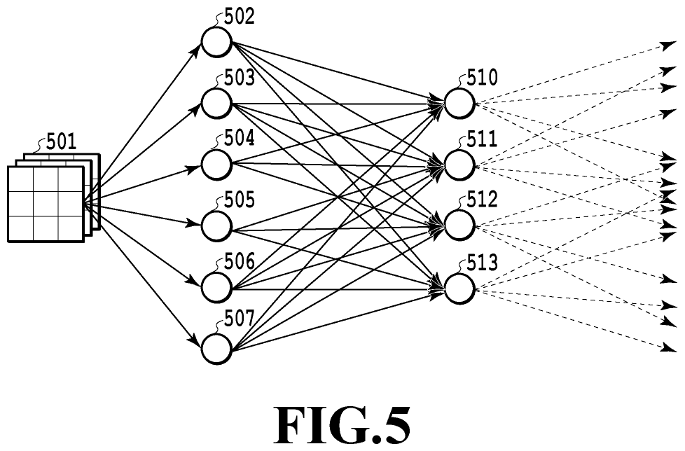

FIG. 5 is a schematic diagram showing the vicinity of an input part of a CNN. In the present embodiment, convolution coefficients may be generated using a personal computer (not shown) as a learning execution apparatus. The learning execution apparatus is not limited to a personal computer, and may be a product such as a printer or a smartphone incorporating a CPU or a processing circuit similar to a CPU, such as or an ASIC or a FPGA. Alternatively, convolution coefficients may be generated by the inferencing execution apparatus 100 through learning.

Data 501 is input data. For example, in a case where input data is image data, the data 501 has 3×3 pixels prepared for each of three R, G, and B channels for every coordinate point, as shown in FIG. 5. Artificial neurons 502 to 507 are elements that process the data 501. In this example, the artificial neurons 502 to 507 hold convolution coefficients for convoluting the data 501. Each artificial neuron holds convolution coefficients for each of the three R, G, and B channels. As will be described later, at this stage, these values are variables as a generation target. For example, the artificial neuron 502 holds sets of 3×3 convolution coefficients for convoluting the data 501 for the respective three R, G, and B channels. The artificial neurons 502 to 507 can hold convolution coefficients of different characteristics because a single convolution process can extract a single feature value. A plurality of different feature values can be extracted by a plurality of convolution processes. The present embodiment describes an example where a first processing layer having six artificial neurons 502 to 507 and a second processing layer having four artificial neurons 510 to 513 are provided as convolution layers. The first processing layer having the artificial neurons 502 to 507 can extract six feature values and pass them to a subsequent stage after the artificial neurons 502 to 507 each complete the convolution processing. Then, the second processing layer having the artificial neurons 510 to 513 can extract four feature values and pass them to a subsequent stage after the artificial neurons 510 to 513 each complete the convolution processing. In other words, the artificial neurons 510 to 513 receive the feature values extracted by the artificial neurons 502 to 507 and perform convolution processing thereon similarly, thereby extracting four feature values and passing them to a subsequent stage.

### Overview of Learning

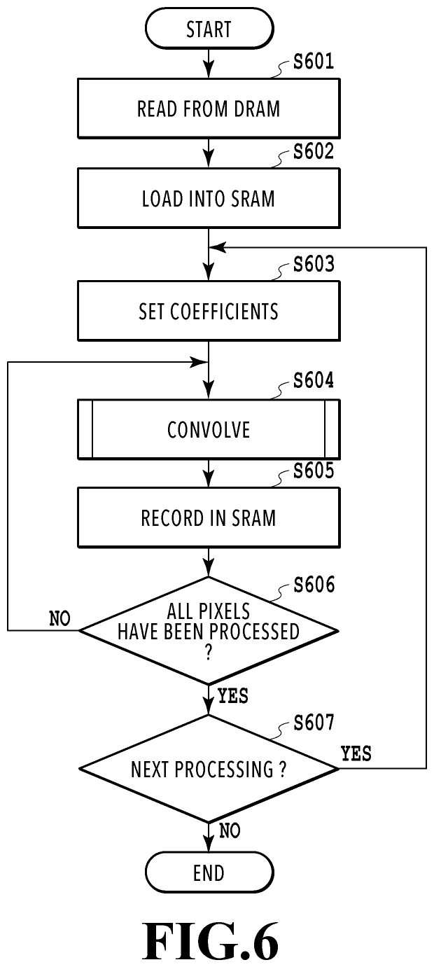

FIG. 6 is a flowchart illustrating an overview of processing executed at the convolution layers. The processing shown in FIG. 6 may be implemented by the CPU 104. The following describes an example where the processing is performed by the CPU 104. Note that some or all of the functions in the steps in FIG. 6 may be implemented by hardware such as an ASIC or an electric circuit. The letter “S” in the description of each process means that it is a step in the flowchart.

The processing shown in FIG. 6 starts once a convolution layer executes learning processing. In S601, the CPU 104 reads input data from the DRAM 103. In S602, the CPU 104 loads the thus-read input data into memory space on the SRAM 401. Based on a program prepared in the ROM 106, the CPU 104 reads convolution coefficients and loads them into memory space on the SRAM 401. Note that it is preferable that the input data and the convolution coefficients be loaded in different areas of the memory space on the SRAM 401. In S603, the CPU 104 sets the convolution coefficients loaded into the memory space on the SRAM 401 to memory space on the register 402. In S604, the CPU 104 performs convolution processing based on the convolution coefficients and a plurality of pixels included in the input data. Details of the processing in S604 will be described later. In S605, the CPU 104 records results of the convolution processing onto the memory space on the SRAM 401. In S606, the CPU 104 determines whether the input data still has data to be processed by the convolution layer, by determining whether all the pixels have already been processed. If not all the pixels have been processed yet, the CPU 104 proceeds from the processing in S606 back to the processing in S604. If all the pixels have already been processed, the CPU 104 proceeds from the processing in S606 to processing in S607. In S607, the CPU 104 determines whether a next filter is needed as next processing. If a next filter is needed, the CPU 104 proceeds from the processing in S607 back to the processing in S603 to set convolution coefficients for the filter of the second convolution layer to the register 402. After that, in S606, the CPU 104 performs convolution processing on the results from the first convolution layer using the convolution coefficients of the filter for the second convolution layer. Then, once processing is completed for all the filters, the CPU 104 ends the processing in S607, thereby ending the processing in S601 to S607.

### Overview of the Artificial Neuron

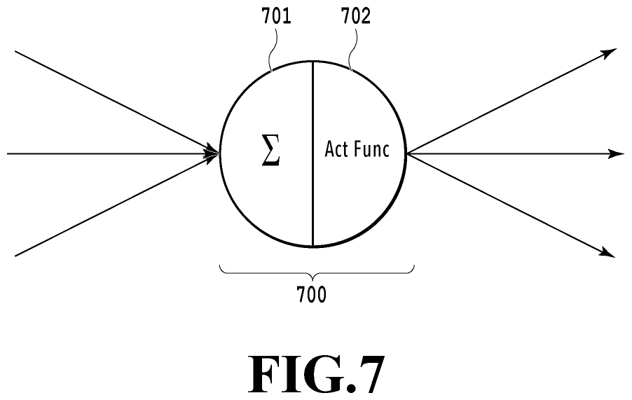

FIG. 7 is a schematic diagram showing details of an artificial neuron 700 constituting a CNN. The artificial neuron 700 has a convolution unit 701 and an activation function unit 702. The artificial neuron 700 is included in a convolution layer. The artificial neuron 700 is a single processing mechanism that receives an input from a stage preceding the convolution layer and outputs a feature value to a subsequent stage side of the convolution layer. The convolution unit 701 performs convolution processing using convolution coefficients. The activation function unit 702 has a function with non-linear characteristics. Specifically, the activation function unit 702 has the softmax function or the ReLU function. The activation function unit 702 performs function processing on an input which is a result from the convolution unit 701 and outputs a result of the function processing. Depending on the result from the convolution unit 701, an output from the activation function unit 702 may be feeble. Specifically, it is dependent on the convolution coefficients used by the convolution unit 701 whether information is transmitted from the activation function unit 702 to the next layer. Such processing is repeated on the next stages to the last stage (not shown) of the model, thereby extracting feature values. In other words, based on a result of convolution processing outputted from the convolution unit 701, the activation function unit 702 calculates a feature value, which is a constituent of a feature vector. Note that, as mentioned earlier, a layer set having plurality of convolution layers is referred to as a convolution layer set. The convolution layer set may have a plurality of pooling layers. The plurality of pooling layers may be disposed after the respective plurality of convolution layers to consolidate a feature vector into a representative value as output data. The consolidation is an operation for extracting one of feature values included in a particular range. For example, the largest value of the plurality of feature values included in a particular range may be extracted, or the average value of the plurality of feature values included in a particular range may be extracted. Also, an upsampling layer may be disposed at a stage subsequent to the convolution layer set. The CPU 104 may extend the output data in the upsampling layer to increase the size of the representative value to the size of the input data and output the result as subsequent-stage data. For example, the upsampling layer enlarges the size of the representative value to the size of the input data by extending the output data in the X and Y directions.

### Convolution Processing

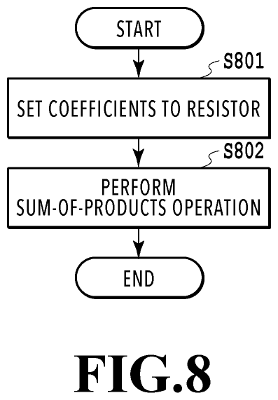

FIG. 8 is a flowchart illustrating convolution processing. The processing shown in FIG. 8 may be implemented by the CPU 104. The following describes an example where the processing is performed by the CPU 104. Note that some or all of the functions in the steps in FIG. 8 may be implemented by hardware such as an ASIC or an electric circuit. The letter “S” in the description of each process means that it is a step in the flowchart.

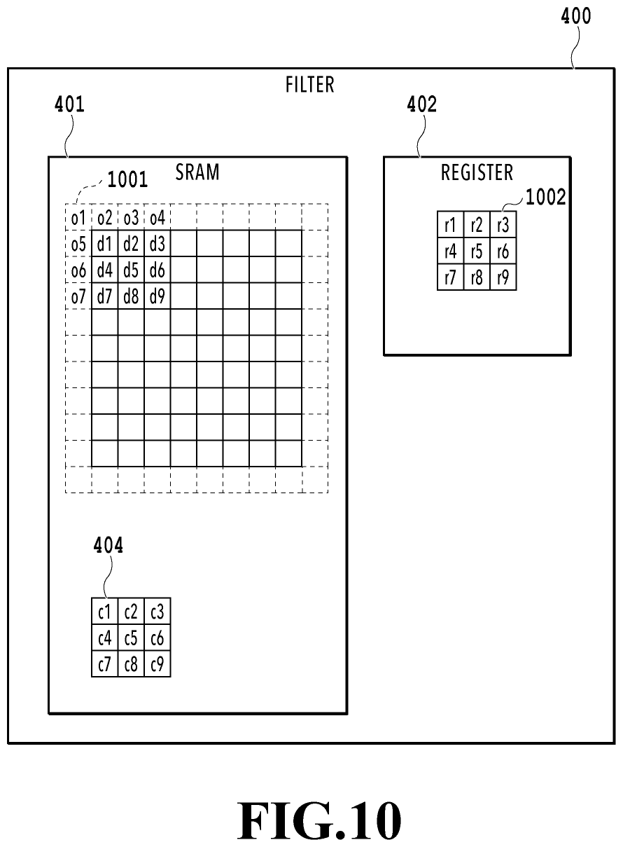

The processing shown in FIG. 8 starts once convolution processing is called. In S801, the CPU 104 sets convolution coefficients to the register 402. In S802, the CPU 104 multiplies one of the plurality of pixels loaded into the memory space on the SRAM 401 by a corresponding one of the convolution coefficients set to the register 402. The CPU 104 collects results of such multiplication performed the same number of times as the number of elements included in one filter 400 and adds them together. The elements included in the filter 400 are convolution coefficients. Thus, the number of elements is the number of convolution coefficients. A more specific description of convolution processing will be given using FIG. 10.

### Obtaining Error

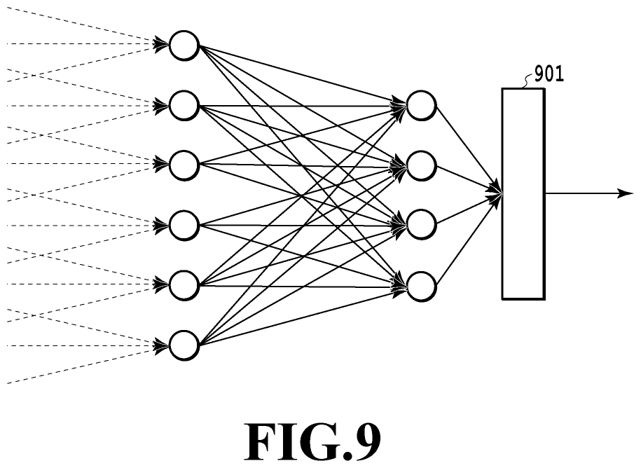

FIG. 9 is a schematic diagram showing the vicinity of an output part of a CNN. An activation layer 901 is shown in the example in FIG. 9. The activation layer 901 has the activation function unit 702. Once the final layer including the artificial neurons 700 in FIG. 7 is reached, a result is outputted through the activation function unit 702. By such an operation, a feature of an image inputted as input data are obtained. Thus, a CNN model obtains feature values from input data using an enormous amount of filter computations and an activation function. Note that the overall configuration of a model formed by processing units including a filter and an activation function depends on the basic design of the model used. In a case where a publicly-known model is used, the overall configuration of the model depends on the basic design of the model. Also, in a case where a model is built from its structure, the configuration of the model is defined by determinations regarding building of the model: how many artificial neurons 700 to use, the size of the filter that the artificial neuron 700 has, and how many layers formed by the artificial neurons 700 to provide. True feature values indicating the features of a subject captured in image data as input data can be prepared using a different method. For example, true feature values can be determined by human judgement based on visual assessment. True feature values are hereinafter referred to as “correct answers”. An error can be obtained by finding a difference between a value obtained by the CNN model and a correct answer. Note that an upsampling layer may be disposed at a stage preceding the activation layer 901. In other words, the activation layer 901 may be disposed at a stage subsequent to an upsampling layer. The activation layer 901 may re-configure subsequent-stage data where data obtained from the preceding stage is mapped. In a case where an upsampling layer is disposed at its preceding stage, the activation layer 901 may obtain subsequent-stage data where the size of a representative value is increased to the size of the input data. In a case where not an upsampling layer but a convolution layer is disposed at its preceding stage, the activation layer 901 may obtain a representative value consolidated from a feature vector. The CPU 104 may classify a subject captured in image data formed by a plurality of pixels based on the subsequent-stage data re-configured by the activation layer 901. The CPU 104 may find convolution coefficients based on the input data and the subsequent-stage image data re-configured by the activation layer 901.

### Detailed Example of Convolution Processing

FIG. 10 is a conceptual circuit diagram of a filter constituting the inference unit 105. As shown in FIG. 10, there is a glue-margin dataset 1001 around pixels d1, d2, d3, d4, and d7. The glue-margin dataset 1001 includes o1 to o7. The glue-margin dataset 1001 is loaded into the memory space on the SRAM 401 to determine r1 in the register 402. The r1 is an index of coordinates in the corresponding convolution processing. Each of r2 and so on is also an index of coordinates in the corresponding convolution processing. After r1 is determined by the convolution processing performed using the glue-margin dataset 1001, the values of o1, o5, and o6 are discarded, and convolution processing is performed using o4, d3, and d6 to determine r2. Convolution processing is similarly performed after that, and results of the convolution processing are transferred to the register 402. In the transfer, processing called padding is performed, embedding “0” for a value of a portion without a pixel. Such glue margin can secure a portion of positional information expected to be lost by convolution processing and therefore can improve the correctness of a feature vector.

### Modification 1 of Glue Margin

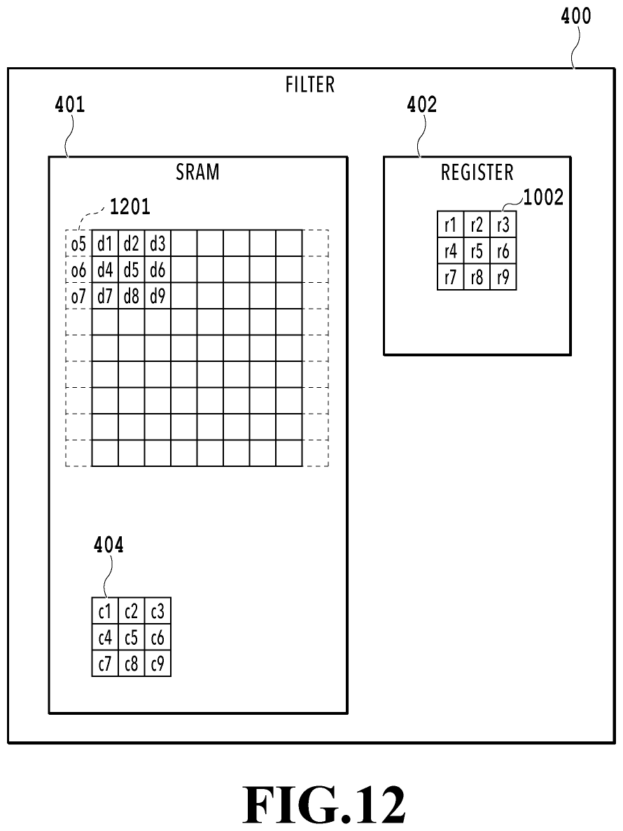

FIG. 12 is a conceptual circuit diagram of a filter constituting the inference unit 105. A less amount of glue margin is used in the example shown in FIG. 12 than in the example shown in FIG. 10. In the example in FIG. 12, a glue-margin dataset 1201 is disposed to the left of d1, d4, and d7. The example in FIG. 12 is favorable for a case where the direction of data progress is the left-right direction because the glue-margin dataset 1201 provides spatial locality in data arrangement in the left-right direction of the memory space on the SRAM 401. Such glue margin too can secure part of positional information to be otherwise lost by convolution processing and therefore can improve the correctness of a feature vector.

### Modification 2 of Glue Margin

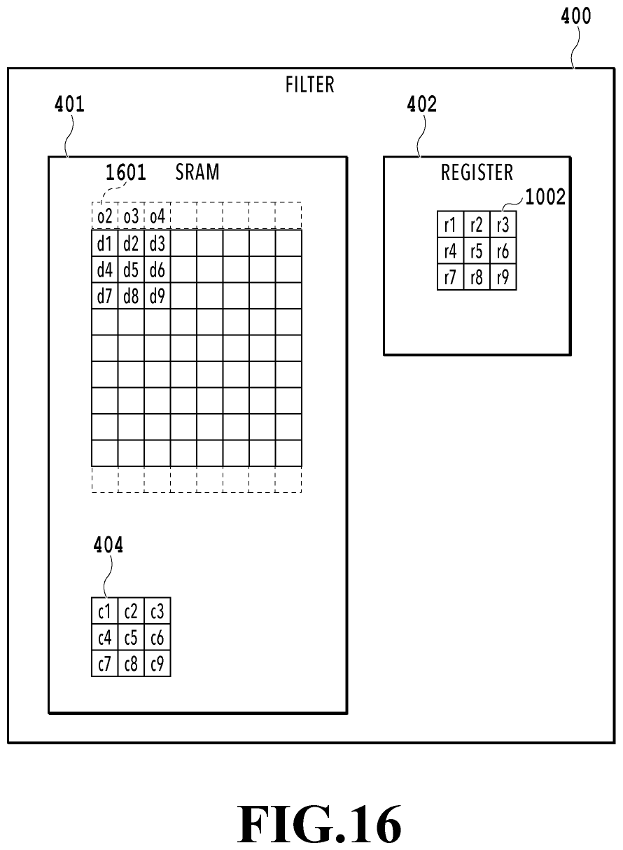

FIG. 16 is a conceptual circuit diagram of a filter constituting the inference unit 105. A less amount of glue margin is used in the example shown in FIG. 16 than in the example shown in FIG. 10. In the example in FIG. 16, a glue-margin dataset 1601 is disposed on the upper side of d1, d2, and d3. The example in FIG. 16 is favorable for a case where the progress of data is in the vertical direction because the glue-margin dataset 1601 provides spatial locality of data arrangement in the vertical direction of the memory space on the SRAM 401. Such glue margin too can secure part of positional information to be otherwise lost by convolution processing and therefore can improve the correctness of a feature vector.

### Modification 3 of Glue Margin

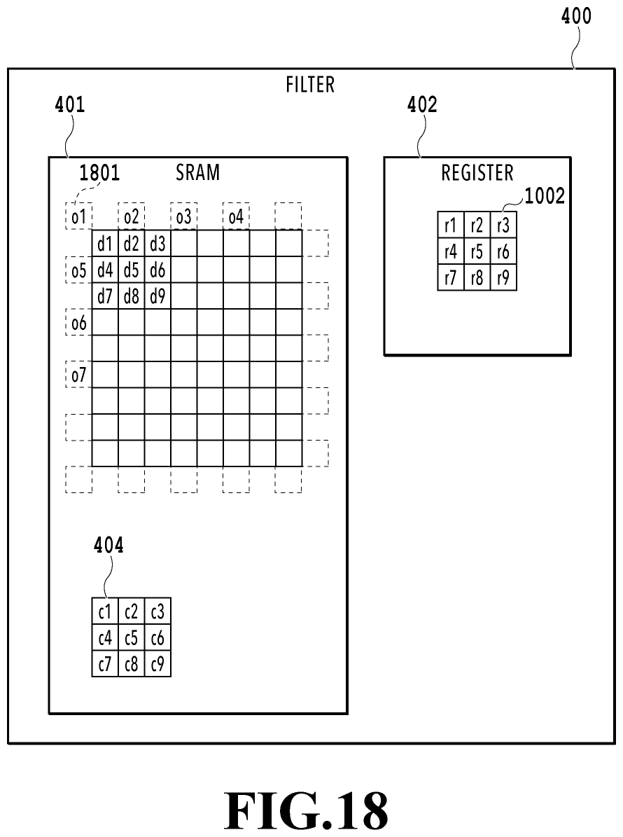

FIG. 18 is a conceptual circuit diagram of a filter constituting the inference unit 105. A less amount of glue margin is used in the example shown in FIG. 18 than in the example shown in FIG. 10. In the example in FIG. 18, a glue-margin dataset 1801 is disposed such that its o1, o2, o3, and o4 are spaced apart with one pixel in between. Also, in the example in FIG. 18, the glue-margin dataset 1801 is disposed such that its o1, o5, o6, and o7 are spaced apart with one pixel in between. The example in FIG. 18 is favorable for a case where the progress of data is at a constant pace because the glue-margin dataset 1801 enables the memory space on the SRAM 401 to have spatial locality of data arrangement at equal intervals. Such glue margin too can secure part of positional information to be otherwise lost by convolution processing and therefore can improve the correctness of a feature vector.

### Learning and a Unit of Processing

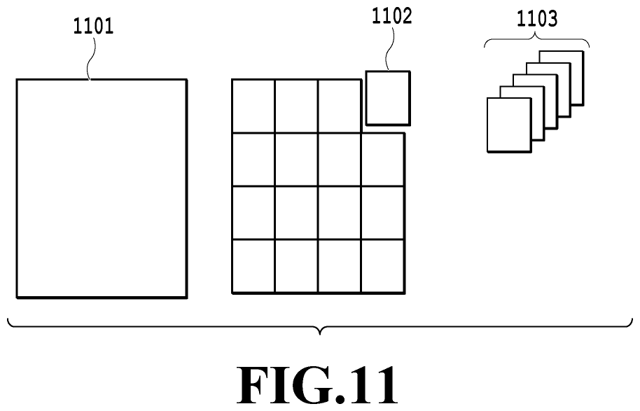

FIG. 11 is a conceptual diagram showing an image used for learning. Dividing and padding of an image are described. An original image 1101 is a given image based on which learning is performed. The original image 1101 is divided into some regions. A divided image 1102 is an image obtained by dividing the original image 1101. A group of padding images 1103 is a group of a plurality of images generated by processing of the divided image 1102. For example, the padding images 1103 are generated through processing such as mirror inversion or overwriting of some of pixels of any image element such as a picture, text, or graphics. Details of a padding method are omitted.

### Learning

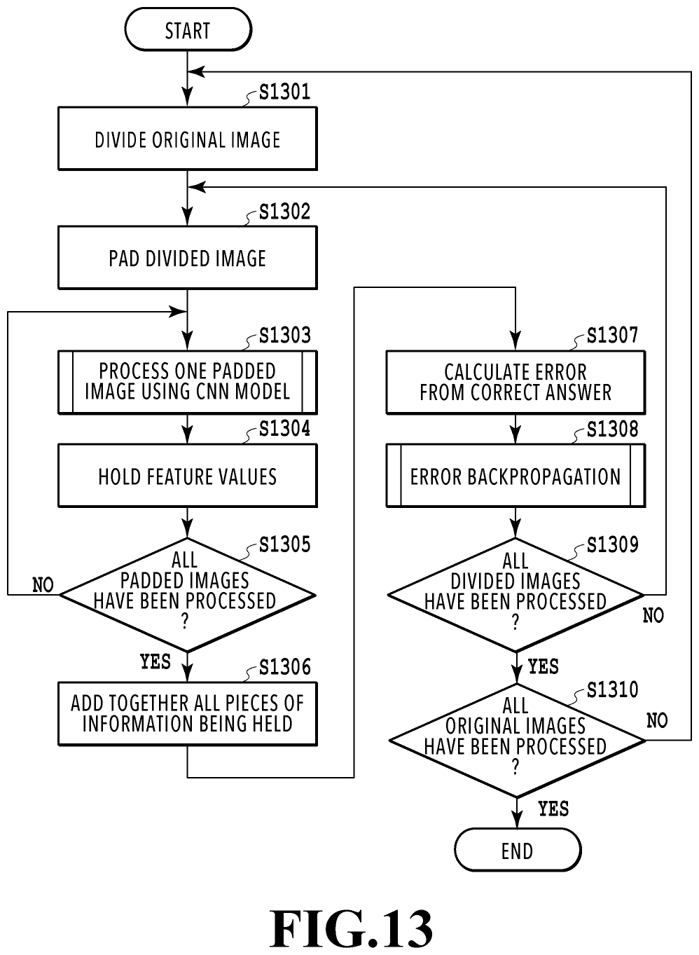

FIG. 13 is a flowchart illustrating learning. The processing shown in FIG. 13 may be implemented by the CPU 104. The following describes an example where the processing is performed by the CPU 104. Note that some or all of the functions in the steps in FIG. 13 may be implemented by hardware such as an ASIC or an electric circuit. The letter “S” in the description of each process means that it is a step in the flowchart.

The processing shown in FIG. 13 starts in response to a user input. Note that a specific embodiment of the user input will be described in a third embodiment. The present embodiment assumes that learning is performed based on a user input. However, in a case where the learning execution apparatus and the inferencing execution apparatus are formed by the same information processing apparatus, the processing may start based on a feedback from the inferencing execution apparatus.

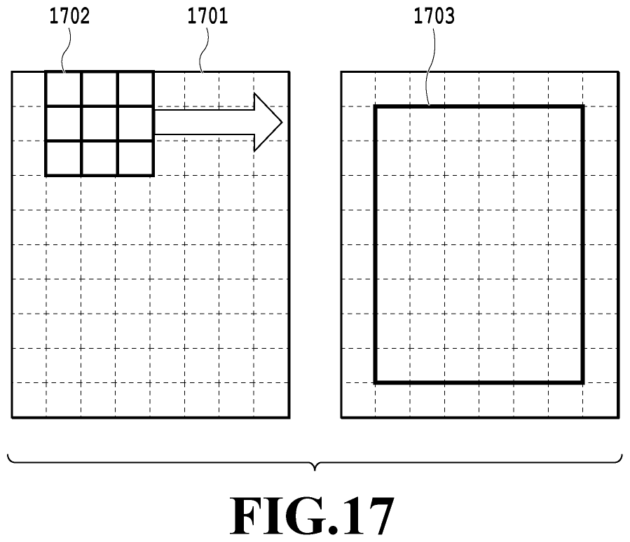

In S1301, the CPU 104 divides a given image used for learning into any given number of parts and thereby obtains the divided image 1102 in FIG. 11. In S1302, the CPU 104 pads the divided image and thereby obtains the group of padding images 1103 in FIG. 11. In S1303, the CPU 104 processes a given image obtained from the group of padding images 1103 using the CNN model. As a result of the processing in S1303, feature values are extracted from the group of padding images 1103. Details of the processing in S1303 is described using FIG. 17. FIG. 17 is a rough schematic diagram of CNN processing. FIG. 17 shows an example where a filter 1702 is applied to a padded enlarged image 1701 to obtain a calculation result of each pixel in a thick-frame region 1703.

In S1304, the CPU 104 holds the feature values extracted. For example, the extracted feature values are held in the SRAM 401. In S1305, the CPU 104 determines whether all the padding images have been processed. If all the padding images have been processed, the CPU 104 proceeds from the processing in S1305 to processing in S1306. If not all the padding images have been processed, the CPU 104 proceeds from the processing in S1305 back to the processing in S1303. In S1306, the CPU 104 adds together all the pieces of information held. Specifically, the CPU 104 finds the sum of all the feature values held in the processing in S1304. The sum of all the feature values is hereinafter referred to as a “total feature value”. In S1307, the CPU 104 finds, as an error, the difference between the total feature value and a feature value of a correct answer obtained by addition performed the same number of times as the padding processing. In S1308, the CPU 104 propagates the error in a direction opposite from the forward propagation direction using the error backpropagation method and updates the convolution coefficients specified on the filter that each convolution layer has. Note that the error backpropagation method is a publicly known technique and is therefore not described here. In S1309, the CPU 104 determines whether error propagation has been completed for all the divided images 1102. If not, the CPU 104 proceeds from the processing in S1310 back to S1302 and starts processing the next divided image from padding. Note that the next processing uses convolution coefficients and transposed convolution coefficients reflecting the result of error backpropagation executed in the processing immediately before. By repeating such error backpropagation processing, the convolution coefficients and the transposed convolution coefficients are sequentially optimized. If error propagation has been completed for all the divided images 1102, the CPU 104 proceeds from the processing in S1309 to processing in S1310. In S1310, the CPU 104 determines whether all the images have been processed. If not, the CPU 104 proceeds from the processing in S1310 back to the processing in S1301 to divide a different original image. If all the images have been processed, the CPU 104 ends the processing in S1301 to S1310. Finding convolution coefficients and transposed convolution coefficients used by the model by propagating an error between a known correct answer and a feature vector obtained by the model in a direction opposite from the forward propagation direction is called learning. The convolution coefficients and the transposed convolution coefficients thus obtained are stored as parameters in the ROM 106 of the product in advance, and this enables inferencing to be executed in the product. Although image padding is performed after image division in the present embodiment, the present disclosure is not particularly limited to this. Specifically, an original image may be padded first, and then the image may be divided after that.

### Execution of Inferencing

A parameter thus obtained is outputted as a probability of a result of recognition of what kind of image input data is. By thus evaluating the degree of match with a type pattern as a probability, a pattern can be identified. Note that as an example, the present embodiment describes convolution using two-dimensional image data and a two-dimensional filter. However, the present disclosure is not limited to this application. Specifically, for example, a similar configuration may be employed for a case where a one-dimensional filter is used for pattern recognition of one-dimensional time-series data, such as audio. Also, a similar configuration may be employed for a case where a three-dimensional filter is used for pattern recognition of three-dimensional data using voxels. Note that in general, the advantageous effects of the present application can be similarly attained by building a configuration suitable for the dimension of feature values.

### Details of a Skip Connection

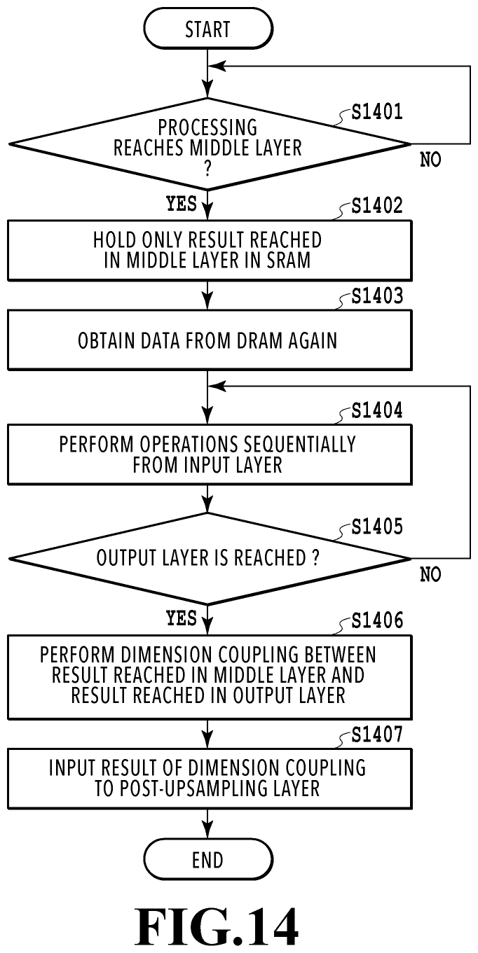

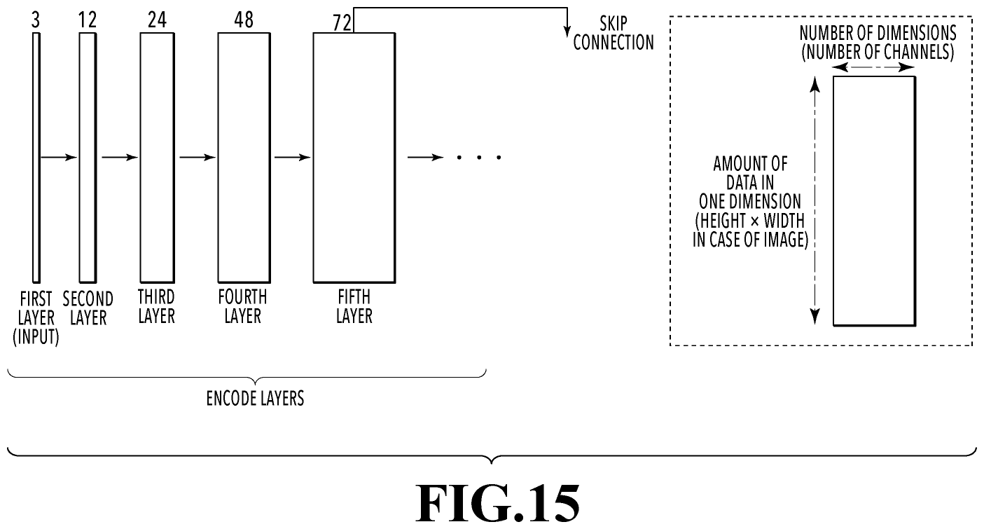

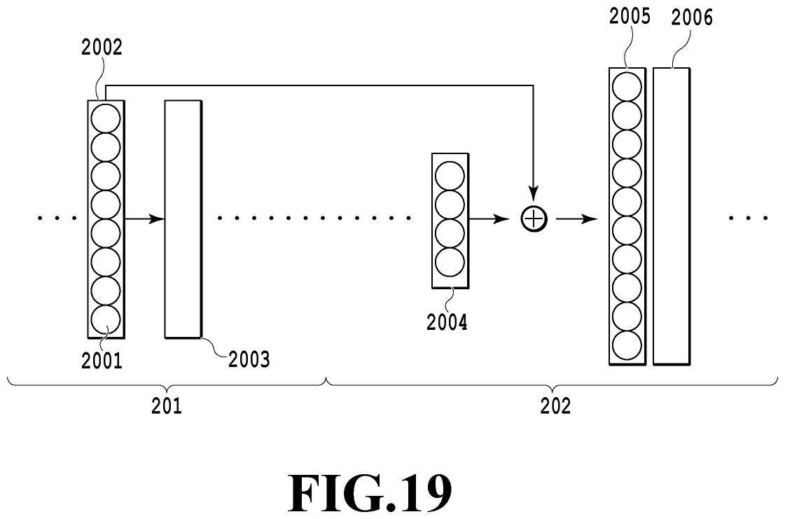

Next, details of a skip connection are described using FIGS. 14, 15, 19, and 20. First, FIGS. 19, 20, and 15 are used to describe the configuration of a skip connection, and FIG. 14 is used to describe an example operation of a skip connection. FIG. 19 is a schematic diagram illustrating a skip connection using dimension-compressed feature vector. FIG. 19 shows an example where the encode layers 201 include an output layer 2002 and a next layer 2003 and the decode layers 202 include a middle layer 2004, a post-upsampling layer 2005, and a next layer 2006. The post-upsampling layer 2005 has a function similar to that of the upsampling layer described above. The middle layer 2004 is the final one of the layers to be skipped by a skip connection and includes a convolution layer. Specifically, a bypass path and a forward propagation path are formed: the bypass path starting from an input layer (not shown) and bypassing layers between the output layer 2002 and the middle layer 2004, and the forward propagation path extending from the input layer (not shown) to the middle layer 2004. The convolution layers included in the bypass path are convolution layers included up to the output layer 2002. Although not shown, convolution layers are disposed on the preceding stage side of the output layer 2002. For example, in a case where the model is SegNet or U-Net, a plurality of convolution layers and pooling layers are disposed at the preceding stage side of the output layer 2002. Note that, for example, information passed on in a skip connection is all the feature values in a case where the model is U-Net, but is an index of pooling coordinates in a case where the model is SegNet. An index of pooling coordinates is information indicating the location of pooling. Although FIG. 19 shows an example where the output layer 2002 includes a plurality of artificial neurons 2001, it is to be noted that each of the next layer 2003, the middle layer 2004, the post-upsampling layer 2005, and the next layer 2006 similarly includes artificial neurons. Focusing on a single artificial neuron 2001 here, the artificial neuron 2001 receives a feature vector from a layer disposed at its preceding stage (not shown) and calculates a feature value. This feature value is one channel. For example, the output layer 2002 outputs a feature vector of eight channels. Input data is processed for analysis in the forward propagation direction. Thus, these feature values for eight channels are inputted to the next layer 2003. Meanwhile, on the decode side, a feature vector is inputted from the middle layer 2004 to the post-upsampling layer 2005. In this event, dimensions are concatenated between the feature vector from the output layer 2002 and the feature vector from the middle layer 2004. A description is now given of the feature vector from the output layer 2002 used for a skip connection. In the present embodiment, the number of channels of the feature vector is culled. For example, from the three RGB channels, only the R channel is discarded, and the two GB channels are used for dimension concatenation. Specifically, the dimensions of the feature vector used for a skip connection are restricted to one or more channels to seven or fewer channels. The more the channels, the more effective a skip connection tends to be. However, with fewer channels, less memory space on the SRAM is used. This is because a skip connection includes processing for sequentially rewriting the convolution coefficients of one filter held in the memory space on the SRAM and also holding processing results. Also, performing a skip connection with channels being culled is effective in reducing the processing results thus held. The feature vector thus dimension-concatenated is inputted to the post-upsampling layer 2005. A result of processing performed by the post-upsampling layer 2005 is inputted to the next layer 2006 of the decode layers 202. In this way, SRAM memory space usage by a skip connection can be reduced. In culling the number of channels, a channel to cull can be selected. For example, a culling method can be selected, such as culling consecutive channels together or culling channels discretely. Although there are eight channels here as an example, the number of channels may be any number. Also, layers to connect can be selected in any way. In the example shown above, the channels of the feature vector are culled in order to reduce SRAM memory space usage by a skip connection. However, channels are not the only target for culling as long as SRAM memory space usage by a skip connection can be reduced. For example, the data length of the feature vector can be culled. For example, out of eight bits for RGB, only four bits are selected, and the rest four bits are discarded. Restricting the data length of a feature vector to less than the original data length of the feature vector is effective in reducing SRAM memory space usage by a skip connection. Culling the number of feature values as calculation results 903 on pixels inside the thick-frame region 1703 in FIG. 17 is also effective in reducing SRAM memory space usage by a skip connection.

In other words, as computation for extracting feature vectors in the bypass path, partial extraction processing is performed, where part of attribute information on the feature vectors is extracted. Further, in a case where a bypass path is used, an output result from the forward propagation path and a result of the partial extraction processing are concatenated. With such a configuration, due to the structure of a convolution neural network, less data is stored in the memory space on the SRAM, making it possible to reduce SRAM memory space usage at all times. Thus, skip connections are enabled at lower costs. Also, as partial extraction processing, information identified based on at least one of the following may be extracted: the dimension of the feature vector, the data length of the feature vector, and pixels included in the feature vector. Such a configuration too makes it possible to use parameters changeable during convolution processing. Also, parameters such as dimensions can be changed while the model is learning.

Although error propagation is performed in a direction opposite from the forward propagation direction, i.e., from the post-upsampling layer 2005 to the middle layer 2004, it is to be noted that convolution coefficients are updated until they reach weights that mitigate gradient vanishing and reduce error. A further description is given on this point. The output layer 2002 originally outputs a feature vector of eight channels. However, in building of a CNN model using machine learning, it is not possible to determine which channel is favorable for data analysis. Thus, through learning, a heavier weight is applied to a favorable channel. Thus, optimizing the weights of the channels left unculled means that as a result, a skip connection is achieved using only meaningful channels. Alternatively, the strength (amplitude) of each frequency is found by performing Fourier series expansion on one-dimensional data. In this event, cutting high frequency component will do in a case of what is called a low-pass filter, but this is not the case with machine learning. Learning is performed to increase the weight (coefficient) of a meaningful frequency band according to an input. As a result, dimensional compression can be done using only meaningful channels of the feature vector in a skip connection. In this way, SRAM memory space usage can be reduced with performance degradation mitigated. Note that any values may be used as initial convolution coefficients to be optimized using such an error backpropagation method.

Incidentally, to enable a skip connection, outputs from neurons in each layer need to be temporarily held in the SRAM memory space. As described earlier, without a skip connection, the SRAM memory space does not need this temporary memory space. Thus, once processing reaches a layer where a skip connection is needed, necessary outputs from the encode layers may be re-extracted (also referred to as re-generation where appropriate). Specifically, once processing reaches the middle layer 2004, the CPU 104 holds only the result therefrom in the memory space on the SRAM 401. Also, the CPU 104 obtains input data from the DRAM 103 again and performs processing from the input layer 203 in the forward propagation direction. Once the processing reaches the output layer 2002, the CPU 104 performs dimension concatenation with the result from the middle layer 2004 previously held and inputs the result to the post-upsampling layer 2005. By performing such an operation in execution of inferencing, the CPU 104 can reduce SRAM memory space usage by the CNN. In the SRAM memory space usage reducing method described above, processing progresses from the input layer 203 in the forward propagation direction in order to re-extract the outputs from the encode layers 201 which are necessary for dimension concatenation. However, the direction in which processing progresses in performing re-extraction does not necessarily need to be the forward propagation direction. For example, by holding the feature vector outputted from the output layer 2002 of the encode layers 201 in the SRAM memory space, the processing may be started from that feature vector. This example will be described using FIG. 15.

### Modification of a Skip Connection

FIG. 15 is a diagram showing an example where the feature vector in the fifth layer is skip-connected. FIG. 15 shows an example where a plurality of layers are disposed as encode layers. The layers are processed the forward propagation direction. Also, as the processing progresses in the forward propagation direction, the number of dimensions (the number of channels) increases. It is possible to hold feature values of the layer with 24 dimensions. With such an operation, re-calculation needs to be done only from the layer with 24 dimensions, and thus calculation efficiency can be increased. Although the model shown in the example in FIG. 15 includes encode layers, there is no particular limitation as to the subsequent stage side of the encode layers. For example, the model may have decode layers disposed on the subsequent stage side of the encode layers, or the model may be formed only of encode layers or only of decode layers.

The present example thus far described the following methods as a method for reducing SRAM memory space usage by a skip connection: feature values held in the SRAM memory space are reduced by culling the feature values; and feature values necessary for a skip connection are not held in the SRAM, but re-extracted once the necessary layer is reached. Which method to use to reduce SRAM memory space usage can be selected for every layer. The method where feature values are re-extracted once the necessary layer is reached is more effective in reducing SRAM memory space usage by a skip connection because a skip connection can be established without having to keep holding feature values for the skip connection in the SRAM memory space. Thus, from the perspective of the effectiveness of reducing usage of the SRAM memory space, it is better to use the method involving re-extraction of feature values. This method, however, requires more processing because re-extraction of feature values requires redoing of processing already performed. Which method to select for each layer is a trade-off between SRAM memory space usage and processing speed because with larger processing amount, processing with parallelism can be executed simultaneously, which consequently increases processing speed as a whole.

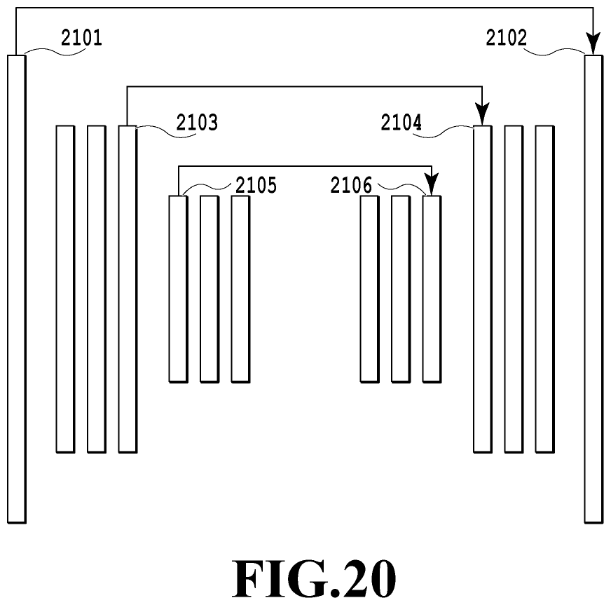

FIG. 20 is a schematic diagram of a model which employs a skip connection. In re-extraction of feature values for dimension concatenation, the amount of processing for the re-extraction increases more and more as the layer in the encode layers is deeper in the forward propagation direction. It is assumed that output layers 2101, 2103, and 2105 disposed in FIG. 20 each have at least one convolution layer disposed at a stage preceding thereto. Also, the output layer 2101 is connected to a dimension concatenation layer 2102 by a skip connection. The output layer 2103 is connected to a dimension concatenation layer 2104 by a skip connection. The output layer 2105 is connected to a dimension concatenation layer 2106 by a skip connection. The following describes re-extraction of outputs from the output layer 2101, the output layer 2103, and the output layer 2105. The skip connection at the output layer 2101 is a path requiring the least amount of processing, whereas the skip connection at the output layer 2105 requires the largest amount of processing. In the present embodiment, the dimension concatenation layer 2102 performs dimension concatenation using the method of re-extraction of feature vectors outputted from the output layer 2101 because, having fewer convolution layers disposed at the preceding stage side than the output layer 2103 or 2105, the output layer 2101 can effectively reduce SRAM memory space usage by a skip connection with a less amount of processing necessary for the re-extraction. Then, the dimension concatenation layer 2104 and the dimension concatenation layer 2106 perform dimension concatenation using the method of culling feature vectors outputted from the output layer 2103 and the output layer 2105 and holding them in the SRAM. The reason for this is described using the dimension concatenation layer 2106 as an example. The dimension concatenation layer 2106 needs to re-extract an output from the output layer 2105. However, the re-extraction of an output from the output layer 2105 requires a large amount of processing because the amount of processing for the re-extraction increases more and more as a layer in the encode layers is deeper in the forward propagation direction. For this reason, the method of holding culled feature values in the SRAM is selected for the output layer 2103 and the output layer 2105. In the present embodiment, the feature value re-extraction method is selected for the output layer 2101, which is closest to the input, and the method of holding culled feature values in the SRAM is selected for the other output layers 2103 and 2105. However, the method may be selected in any way. A better method can be selected for each layer in consideration of a reduction amount of SRAM memory space and processing efficiency. In either case, re-extraction of feature vectors in establishing a skip connection eliminates the need for holding the feature vectors and thus reduces the SRAM memory space usage. Also, in execution of learning, convolution coefficients are optimized by learning of feature vectors equivalent to those for a regular skip connection. Thus, inferencing can be performed at equivalent accuracy, and the advantageous effects of the present application can be offered.

### Operation of a Skip Connection

FIG. 14 is a flowchart showing a re-extraction operation. The processing shown in FIG. 14 may be implemented by the CPU 104. The following describes an example where the processing is performed by the CPU 104. Note that some or all of the functions in the steps in FIG. 14 may be implemented by hardware such as an ASIC or an electric circuit. The letter “S” in the description of each process means that it is a step in the flowchart.

The processing shown in FIG. 14 starts once the CPU 104 starts management of a skip connection. The CPU 104 determines whether processing has reached the middle layer 2004. If processing has reached the middle layer 2004, the CPU 104 proceeds from the processing in S1401 to processing in S1402. If processing has not reached the middle layer 2004 yet, the CPU 104 continues the processing in S1401. In S1402, the CPU 104 holds, in the SRAM 401, only a result reached in the middle layer 2004. In other words, feature vectors extracted by the convolution layers at the preceding stage side of the middle layer 2004 are not held. In S1403, the CPU 104 obtains data from the DRAM 103 again. The data that the CPU 104 obtains from the DRAM 103 again is the input data. In S1404, the CPU 104 performs processing sequentially starting from the input layer. More specifically, the CPU 104 once again finds feature vectors extracted by the convolution layers from the input layer to the output layer 2002. In S1405, the CPU 104 determines whether the output layer 2002 is reached. If the output layer 2002 is reached, the CPU 104 proceeds from the processing in S1405 to processing in S1406. If the output layer 2002 is not reached, the CPU 104 proceeds from the processing in S1405 back to the processing in S1404 to proceed with feature vector extraction processing in each layer until the output layer 2002 is reached. In S1406, the CPU 104 performs dimensional coupling between the result reached in the middle layer 2004 and the result reached in the output layer 2002. More specifically, dimension concatenation is performed between a feature vector re-extracted up to the output layer 2002 and a feature vector reached in the middle layer 2004. Here, during the re-extraction, a coupling element disposed between the middle layer 2004 and the post-upsampling layer 2005 waits for input of re-extracted results. For example, a buffer (a delay element) of a size enough for the re-extraction may be disposed between the middle layer 2004 and the connection element. In S1407, the CPU 104 inputs the result of the dimension concatenation to the post-upsampling layer 2005, and the processing in S1401 to S1407 ends. Note that in S1401 to 1407, in a case where pooling layers are disposed at the subsequent stages of the convolution layers, a feature vector may be consolidated into a representative value as output data.

### Second Embodiment

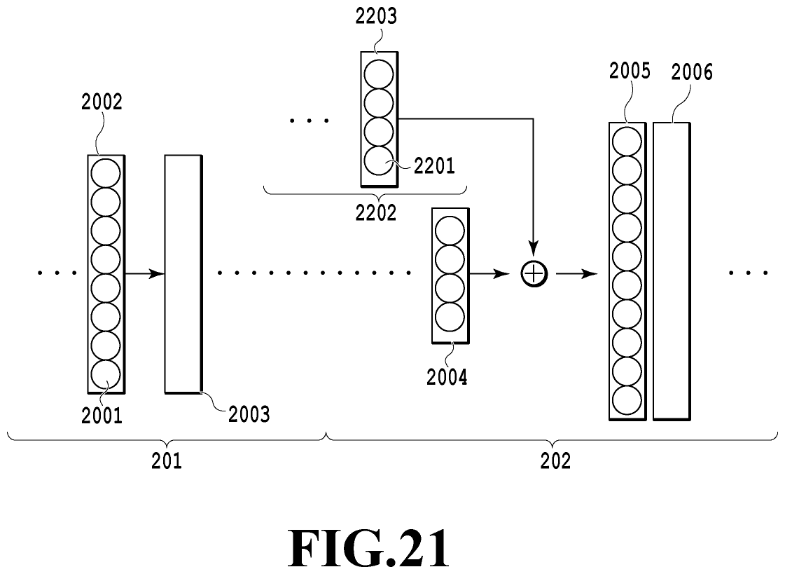

In the first embodiment described above, a method for reducing SRAM memory space usage by a skip connection can be selected between a method of culling feature values and a method of not holding feature values in the SRAM but re-extracting them. No matter which method is selected, SRAM memory space usage can be effectively reduced. Incidentally, a feature vector passed on to the next layer in the encode layers and a feature vector after culling are the same as a feature vector used for dimension concatenation. This poses a problem of determination accuracy being lowered. The preset embodiment describes means for improving determination accuracy while reducing SRAM memory space usage. FIG. 21 is a schematic diagram illustrating details of a skip connection. In the present embodiment, an additional set of encode layers 2022 is disposed. The encode layers 2022 have any given output layer 2203. The output layer 2203 includes a plurality of artificial neurons 2201. A description is given of learning of a CNN model in the present embodiment. Once an image is inputted to the CNN model, the encode layers 201 and the encode layers 2022 are both processed in the forward propagation direction. For example, the output layer 2002 outputs a feature vector of eight channels. The feature vector outputted from the output layer 2002 is inputted to the next layer 2003 disposed at a stage subsequent to the output layer 2002. Meanwhile, in the decode layers 202, a feature vector is inputted from the middle layer 2004 to the post-upsampling layer 2005. In this event, dimension concatenation is performed between a feature vector outputted from the output layer 2203 in the encode layers 2022 and the feature vector outputted from the middle layer 2004. The first embodiment reduces SRAM memory space usage by culling the feature values of the feature vector outputted from the output layer 2002 or re-extracting the feature vector from the output layer 2002 at the time of dimension concatenation. In the present embodiment, the feature vector outputted from the output layer 2203 and used for dimension concatenation can be designed such that the number of channels, the data length, or the pixel count can be equal to or smaller than those of the feature vector obtained by culling or re-extraction in the first embodiment. This is because the model architecture of the encode layers 2022 can be freely changed. As an example, a description is given of a case where the feature vector outputted from the output layer 2203 has the same size as the feature vector obtained by culling or re-extraction for dimension concatenation in the first embodiment. Specifically, a comparison is made using a case in the first embodiment where four out of eight channels are culled for the feature vector outputted from the output layer 2002 to perform dimension concatenation with the feature vector outputted from the middle layer 2004. In the first embodiment, four out of eight channels of the feature vector outputted from the output layer 2002 are used as both an input to the next layer 2003 and the feature vector used for dimension concatenation. Thus, they cannot be optimized in a case where they are separately used in model learning, and filter coefficients need to be determined so that the feature vector may be effective for use in either case. By contrast, in the present embodiment, the feature vector outputted from the output layer 2002 is used only as an input to the next layer 2003. Also, for dimension concatenation with the feature vector outputted from the middle layer 2004, the feature vector outputted from the output layer 2203 is used. It is then possible to optimize these two sets of feature vectors separately in learning and therefore enable improvement in accuracy while reducing usage of memory space on the SRAM 401. In the present embodiment described above, the feature vector outputted from the output layer 2203 and the feature vector after culling or re-extraction in the first embodiment are the same in size. However, they do not necessarily have to be the same. In either case, re-extracting feature vectors in establishing a skip connection can eliminate the need for holding the feature vectors and therefore reduce SRAM memory space usage. Also, in learning, learning is performed separately in the encode layers for feature value extraction and in the encode layers for skip connection to optimize filter coefficients for better accuracy. Thus, inferencing can be performed with equivalent or better accuracy, and advantageous effects of the present embodiment can be offered.

### Third Embodiment

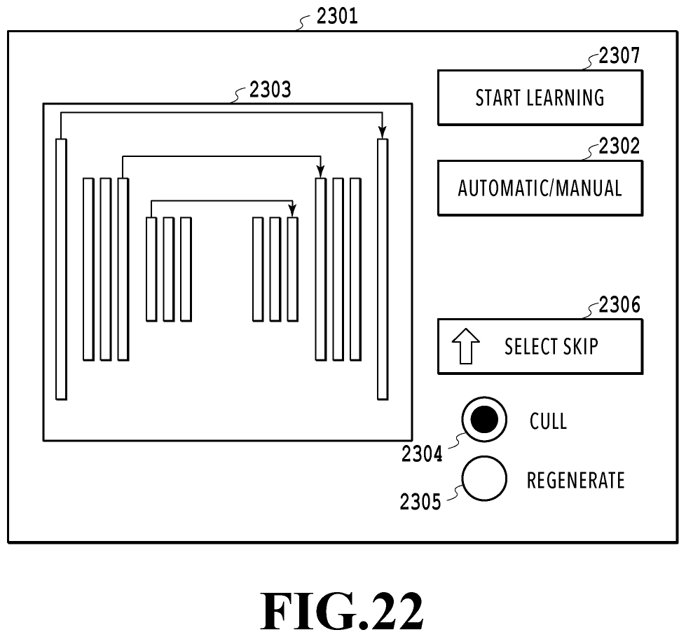

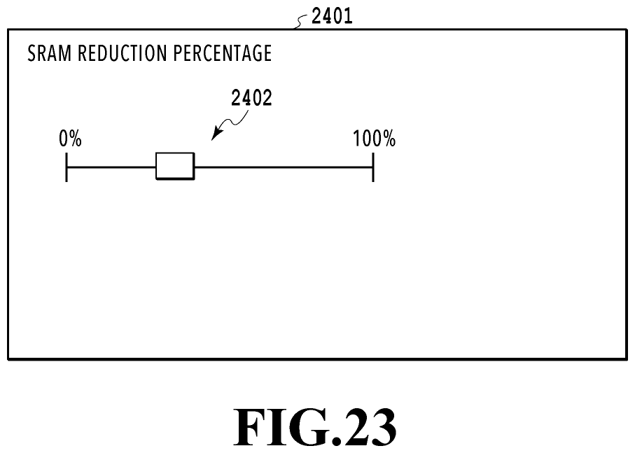

In the first embodiment described above, a method for reducing SRAM memory space usage by a skip connection is selected for each layer between the method of culling feature values and the method of not holding feature values in the SRAM but re-extracting them. In a case where the method with culling feature values is selected, it is necessary to select which of the following elements of a feature vector to cull and how much to cull: the number of channels, the data length, and the number of pixels. In the second embodiment, in addition to the above selection, it is necessary to select the structure of the CNN model that outputs a feature vector used for dimension concatenation. Both of the embodiments can effectively reduce SRAM memory space usage. However, a user needs to select whether to perform culling (and what and how much to cull) or to perform re-extraction. The present embodiment describes a method for reducing SRAM usage while allowing selections regarding reduction of SRAM usage to be made automatically. FIG. 22 is a diagram showing an example of a skip connection settings screen 2301 displayed for learning of a CNN model. FIG. 22 shows the settings screen 2301. The settings screen 2301 functions as a user interface for receiving user operations. Thus, using the settings screen 2301, the user can make selections regarding reduction of SRAM memory space usage. Disposed in the upper right area of the settings screen 2301 are a model design automatic/manual switching button 2302 and a start learning button 2307. Disposed at the lower right area of the settings screen 2301 are a select button 2306, a select culling button 2304, and a select regeneration button 2305. Disposed in the left area of the settings screen 2301 is a CNN model architecture display screen 2303. The model design automatic/manual switching button 2302 receives a selection of whether to make selections regarding reduction of SRAM memory space usage automatically or manually. Although one of two options, automatic and manual, is selected and received in the present embodiment, the present disclosure is not limited to this. More detailed selections may be received. For example, some of model design items may be set manually, and the rest may be set automatically. A description is given next of a case where the model design automatic/manual switching button 2302 is pressed to automatically make selections regarding reduction of SRAM memory space usage by the CNN model. Upon pressing of the model design automatic/manual switching button 2302, the screen transitions to an advanced settings screen for setting information based on which to automatically make selections regarding reduction of SRAM memory space usage. FIG. 23 is a diagram showing an example of the advanced settings screen displayed in learning of a CNN model. Using an advanced settings screen 2401, a user can mainly set how much to reduce SRAM memory space usage by a skip connection. The advanced settings screen 2401 has a setting bar 2402. A user can change the position of the setting bar 2402 in the range from 0% to 100%. Once the setting bar 2402 is operated by a user, the reduction percentage of SRAM memory space usage by a skip connection is received, and the CPU 104 sets CNN model design items based on this reduction percentage. Although the reduction percentage of SRAM memory space usage by a skip connection is received in the present embodiment, the present disclosure is not limited to this. For example, the number of times of the sum-of-product operation, the processing speed, and SRAM memory space usage by the entire CNN model may be received, and based on them, the CPU 104 may make selections regarding reduction of SRAM memory space usage by the CNN model.

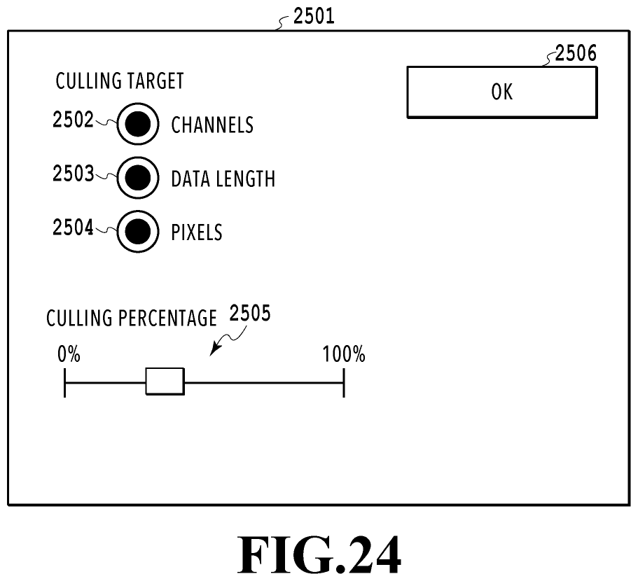

Next, a description is given of a case where the model design automatic/manual switching button 2302 is pressed to manually make selections regarding reduction of SRAM memory space usage by the CNN model. The CNN model architecture display screen 2303 presents a schematic diagram of the CNN model. In a case of manually making selections regarding reduction of SRAM memory space usage by the CNN model, a method for reducing SRAM memory space usage by a skip connection can be set for each of the layers relevant to the skip connection. The select culling button 2304 and the select regeneration button 2305 represent options of the SRAM memory space usage reducing method described in the first embodiment. Specifically, the CPU 104 receives a user selection of either the feature vector culling method or the feature vector re-generation method. Although the present embodiment receives a selection made from the two SRAM memory space usage reducing methods described in the first embodiment, the present disclosure is not limited to this. For example, an SRAM memory space usage reducing method where different coefficient filters are used between encoding and dimension concatenation as described in the second embodiment may be selected and received. For each of the layers to be skip-connected, the select button 2306 is pressed with either the select culling button 2304 or the select regeneration button 2305 being selected. The SRAM memory space usage reducing method can thus be set for each layer. In a case where the select button 2306 is pressed with the select culling button 2304 being selected for any of the layers to be skip-connected, the screen transitions to an advanced settings screen for setting which element to cull and how much to cull. FIG. 24 is a diagram showing an advanced settings screen 2501, which is another example of the advanced settings screen displayed in learning of a CNN model. The advanced settings screen 2501 is the screen to which the skip connection settings screen 2301 transitions once the select button 2306 is pressed with the select culling button 2304 being selected. Disposed in the upper right area of the advanced settings screen 2501 is an OK button 2506. Disposed in the upper left area of the advanced settings screen 2501 are a select channel button 2502, a select data length button 2503, and a select pixel button 2504. Each of the select channel button 2502, the select data length button 2503, and the select pixel button 2504 receives a selection of the element to cull in order to reduce SRAM memory space usage. A setting bar 2505 is disposed in the lower left area of the advanced settings screen 2501. The setting bar 2505 operates in correspondence to one of the buttons disposed in the upper left area of the advanced settings screen 2501. Specifically, in a case where the select channel button 2502 is selected, the setting bar 2505 receives the percentage of culling the corresponding element: channels. In a case where the select data length button 2503 is selected, the setting bar 2505 receives the percentage of culling the corresponding element: data length. In a case where the select pixel button 2504 is selected, the setting bar 2505 receives the percentage of culling the corresponding element: pixels. Once the OK button 2506 is pressed after the setting bar 2505 is operated for the selected culling element, the selected settings for reducing SRAM memory space usage can be applied to the layer to be skip-connected. Referring back to FIG. 22, in learning of the CNN model with reduced SRAM memory space usage, learning of the CNN model starts once the settings are inputted and the start learning button 2307 is pressed. The present embodiment shows an example of the settings screen 2301 used in learning of a CNN model with reduced SRAM memory space usage by a skip connection. However, settable items are not limited to the ones above. The settings screen may also have means for inputting learning conditions for learning, means for stopping learning midway, means for executing inferencing, or the like. Also, the format of the screen is not limited to the above and may have a different arrangement of items and different input means from the ones in the present embodiment.

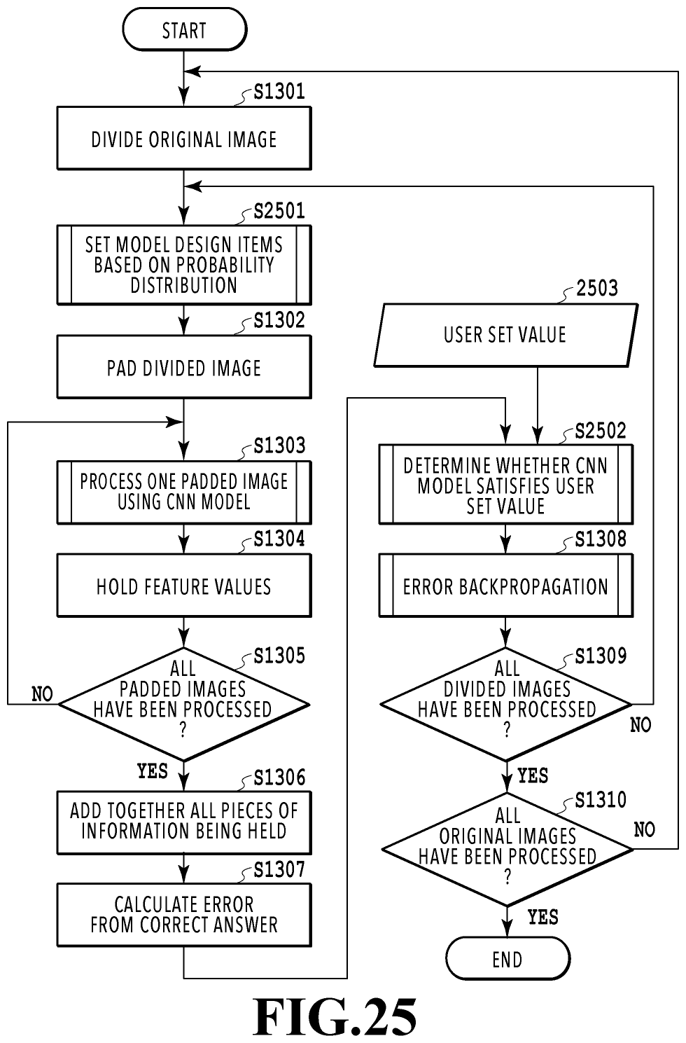

Next, a description is given of an example of how selections regarding reduction of SRAM memory space usage by a CNN model are made automatically. In general, there is a method called neural architecture search (NAS) as a method for searching for a CNN model with high accuracy. In this method, a search can be made to find a model architecture with high accuracy or a selection regarding reduction of SRAM memory space usage. The reason for this is because in learning, the suitability of the model architecture and the set values of design items can be reflected in error. FIG. 25 is a flowchart showing automatic CNN model designing. The processing shown in FIG. 25 may be implemented by the CPU 104. The following describes an example where the processing is performed by the CPU 104. Note that some or all of the functions in the steps in FIG. 25 may be implemented by hardware such as an ASIC or an electric circuit. The letter “S” in the description of each process means that it is a step in the flowchart.

The processing shown in FIG. 25 starts once a user presses the start learning button 2307. Processing shown in FIG. 25 which is the same as the processing shown in FIG. 13 is denoted by the same step number, and its description is omitted. In S2501, the CPU 104 sets model design items based on a probability distribution. The model design items are items such as, for example, a model architecture and a selection regarding reduction of SRAM memory space usage. A model architecture is the architecture of a model specified by, for example, SegNet, U-Net, or ResNet. The probability distribution may be a random distribution at the initial stage of the learning. As the learning progresses, this probability distribution changes so that a set value that makes the error from the correct answer calculated in S1307 small is more likely selected. In S2502, the CPU 104 receives input of a user set value in FIG. 25 configured by the user through the settings screen 2301. The CPU 104 determines whether the set CNN model satisfies the user set value in FIG. 25. A term “penalty” as defined herein is an evaluation index reflecting whether the CNN set in S2501 satisfies the user set value in FIG. 25. In the present embodiment, in a case where the CNN model satisfies the user set value in FIG. 25, the value of the penalty is “0”. Meanwhile, in a case where the CNN model does not satisfy the user set value in FIG. 25, the value of the penalty increases according to the magnitude of a deviation from the user set value in FIG. 25. For example, in a case where the user sets 50% as the percentage of reduction of SRAM memory space usage by a skip connection, the set value is inputted to S2502 as the set value in FIG. 25. In S2501, a method for reducing SRAM memory space usage is set for each of the layers to be skip-connected by the CPU 104. Thus, it is possible to calculate how much SRAM memory space usage can be reduced compared to a case where SRAM memory space usage is not reduced. The CPU 104 compares the value thus calculated with the user set value in FIG. 25, and if the CNN model satisfies the user set value in FIG. 25, the output from S1307 is used in S1308 as is. Meanwhile, if the CNN model does not satisfy the user set value in FIG. 25, the CPU 104 reflects the penalty value in the output from S1307 and uses it in S1308. The reason for this is because it is necessary to make it unlikely for the combination of set values selected in S2501 to be selected. In an example method, in a case where the percentage of reduction of SRAM memory space usage is 50% or higher, no penalty is given, and in a case where the percentage of reduction of SRAM memory space usage is lower than 50%, a penalty in accordance with the deficient percentage of reduction is added. In the present embodiment, a penalty is added to the output from S1307. However, how a penalty is given is not limited to this. For example, the output from S1307 may be multiplied by a penalty according to the deficient percentage of reduction. As a result of this operation, the value used in S1308 reflects not only the determination performance of the CNN model, but also the suitability of the selection regarding reduction of SRAM memory space usage set in S2501. In the back error propagation performed in S1308, the convolution coefficients of the CNN model and the selection regarding reduction of SRAM memory space usage set in S2501 can be optimized. Also, although the processing in S2502 is executed between S1307 and S1308 in the present embodiment, the present disclosure is not particularly limited to this. The evaluation in S2502 may be executed anytime between S1301 and S1308. Also, S2502 does not have to be performed in every iteration of the processing from S1301 to S1310. In any case, re-extraction of feature vectors for a skip connection can eliminate the need to hold the feature vectors and reduce SRAM usage. Also, in learning, selections regarding reduction of SRAM memory space usage are automatically learned, and convolution coefficients, the model architecture, and set values are optimized for better accuracy. Thus, a decrease in accuracy can be effectively mitigated.

Although the present disclosure has been described using various examples and embodiments, the gist and scope of the present disclosure are not limited to particular matters described herein.

For example, a CNN model including encode layers and decode layers is described in the above embodiments as an example. Also, in the example described herein as a method for reducing SRAM memory space usage by dimension concatenation, dimension concatenation is performed between an output from an output layer in the encode layers and an output from a middle layer in the decode layers. However, a CNN model does not necessarily have to include encode layers and decode layers. Dimension concatenation can be performed in, for example, a CNN model including encode layers, but not decode layers. Also, outputs from two or more output layers in the encode layers may be dimension-concatenated and inputted to the next layer. SRAM memory space usage can be effectively reduced for such CNN models as well using the methods used in the above embodiments as a method for reducing SRAM memory space usage by dimension concatenation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-043653, which was filed on Mar. 19, 2024 and which is hereby incorporated by reference herein in its entirety.

What is claimed is:

1. An information processing apparatus including a plurality of convolution layers, the information processing apparatus comprising:
at least one memory storing a plurality of convolution layers; and
a processor connected to the at least one memory,
wherein the processor propagates convolution output data based on a feature quantity vector extracted from input data from a preceding stage side at each of the plurality of convolution layers to a subsequent stage side,
concatenates a forward propagation path in which the output data is propagated sequentially through each of the plurality of convolution layers with a bypass path in which the output data is propagated while bypassing part of the forward propagation path,
performs convolution processing of extracting the feature quantity vector from the input data at each of the plurality of convolution layers,
in the processing of extracting the feature quantity vector, as processing of extracting the feature vector in the bypass path, performs partial extraction processing to extract part of attribute information on the feature quantity vector, and
in the concatenating of the forward propagation path with the bypass path, in a case where the bypass path is used, concatenates an output result from the forward propagation path and a result of the partial extraction processing.

2. The information processing apparatus according to claim 1, wherein
as the partial extraction processing, the processor extracts information identified based on at least one of a dimension of the feature quantity vector, data length of the feature quantity vector, and pixels included in the feature vector.

3. The information processing apparatus according to claim 2, wherein
the input data is formed by a plurality of pixels,
each of the plurality of convolution layers includes a filter where a plurality of convolution coefficients are specified, and
in each of the plurality of convolution layers, the processor extracts the feature quantity vector by performing convolution processing based on the plurality of pixels and the plurality of convolution coefficients.

4. The information processing apparatus according to claim 3, wherein
a convolution layer set including the plurality of convolution layers includes a plurality of pooling layers, and
the plurality of pooling layers are disposed at the subsequent stage side of the respective plurality of convolution layers and consolidate the feature vector into a representative value as the output data.

5. The information processing apparatus according to claim 4, further comprising an upsampling layer disposed at the subsequent stage side of the convolution layer set and configured to extend the output data, wherein
in the upsampling layer, the processor increases a size of the representative value to a size of the input data by extending the output data and outputs the output data as subsequent-stage data.

6. The information processing apparatus according to claim 5, further comprising an activation layer disposed at the subsequent stage side of the upsampling layer and configured to re-configure subsequent-stage image data where the subsequent-stage data is mapped, wherein
the processor classifies a subject captured in image data formed by the plurality of pixels based on the subsequent-stage image data re-configured by the activation layer.

7. The information processing apparatus according to claim 4, further comprising an activation layer disposed at the subsequent stage side of the convolution layer set and configured to re-configure subsequent-stage image data where the representative value is mapped, wherein
based on the subsequent-stage image data re-configured by the activation layer, the processor classifies a subject captured in image data formed by the plurality of pixels.

8. The information processing apparatus according to claim 6, wherein
each of the plurality of convolution layers includes a plurality of artificial neurons,
each of the plurality of artificial neurons performs the convolution processing using the convolution coefficients, and based on a result of the convolution processing, calculates a feature quantity that is a constituent component of the feature quantity vector, and
the processor finds the convolution coefficients based on the input data and the subsequent-stage image data re-configured by the activation layer.

9. The information processing apparatus according to claim 3, wherein the processor performs a sum-of-product operation on the input data while shifting the filter with a certain stride to find feature quantities representing local features of the input data at every shift of the filter, and extracts a set of the feature quantities as the feature quantity vector.

10. The information processing apparatus according to claim 1, wherein
the at least one memory includes
a first memory device functioning as main memory and
a second memory device functioning as cache memory,
the first memory device stores the input data, and
the second memory device stores the feature quantity vector extracted at each of the plurality of convolution layers.

11. The information processing apparatus according to claim 10, wherein
in performing the partial extraction processing, the processor obtains the input data from the first memory device.

12. The information processing apparatus according to claim 10, wherein
the first memory device is formed of DRAM, and
the second memory device is formed of SRAM.

13. The information processing apparatus according to claim 3, wherein
divided data obtained by dividing image data formed of the input data into certain spatial regions is inputted to the convolution layer set.

14. An information processing method for an information processing apparatus including a plurality of convolution layers, the information processing method comprising:
causing each of the plurality of convolution layers to propagate output data to a subsequent stage side, the output data being based on a feature quantity vector extracted from input data inputted from a preceding stage side;
concatenating a forward propagation path in which the output data is propagated sequentially through each of the plurality of convolution layers with a bypass path in which the output data is propagated while bypassing part of the forward propagation path; and
causing each of the plurality of convolution layers to perform processing for extracting the feature quantity vector from the input data, wherein
in the causing each of the plurality of convolution layers to perform processing, partial extraction processing to extract part of attribute information on the feature quantity vector is performed as processing for extracting the feature quantity vector in the bypass path, and
in the concatenating, in a case where the bypass path is used, an output result from the forward propagation path with a result of the partial extraction processing are concatenated.

15. A non-transitory computer-readable storage medium storing instructions that, when executed by a computer, cause the computer to execute:
causing each of a plurality of convolution layers to propagate output data to a subsequent stage side, the output data being based on a feature quantity vector extracted from input data inputted from a preceding stage side;
concatenating a forward propagation path in which the output data is propagated sequentially through each of the plurality of convolution layers with a bypass path in which the output data is propagated while bypassing part of the forward propagation path;
causing each of the plurality of convolution layers to perform processing for extracting the feature vector from the input data;
in the causing each of the plurality of convolution layers to perform processing, performing partial extraction processing to extract part of attribute information on the feature vector, as processing for extracting the feature quantity vector in the bypass path; and
in the concatenating of the forward propagation path and the bypass path, in a case where the bypass path is used, coupling an output result from the forward propagation path with a result of the partial extraction processing.
